(19) United States
(12) Patent Application Publication
(10) Pub. No.: US 2011/0009015 A1
(43) Pub. Date: Jan. 13, 2011

(54) FRETTING-RESISTANT CONNECTOR AND PROCESS FOR MANUFACTURING THE SAME

(75) Inventors: Kazuo Yoshida, Tokyo (JP); Yoshiaki Kobayashi, Tokyo (JP)

Correspondence Address: BIRCH STEWART KOLASCH & BIRCH, PO BOX 747, FALLS CHURCH, VA, 22040-0747, US

(73) Assignee: THE FURUKAWA ELECTRIC CO., LTD., Tokyo (JP)

(21) Appl. No.: 12/667,195

(22) PCT Filed: Jun. 30, 2008
(86) PCT No.: PCT/JP2008/061868

§ 371 Date: Mar. 25, 2010

(30) Foreign Application Priority Data
Jun. 29, 2007 (JP) 2007-173335

(51) Int. Cl. H01R 13/03; B05D 5/12

(52) U.S. Cl. 439/886; 427/58

(57) ABSTRACT

A fretting-resistant connector, having an organic coating that is formed of an organic compound which has an ether linkage group at least a part on a surface of an electrically conductive metal material.

### TECHNICAL FIELD

The present invention relates to a fretting-resistant connector and a process for manufacturing such the connector.

### BACKGROUND ART

In the recent years, there becomes progressing on a connector to be as a multi way type in order to connect to between wires as a plurality thereof with making use of such the connector as just one for a usage of such as a motor vehicle or the like in which there is increasing rapidly a wiring of an electric signal. And then in such a case where there is designed for such the connector to be as the multi way type therefor, it becomes to be required for male terminals and female terminals as individually a plurality thereof to be performed an insertion thereinto with all together at a same time thereof, that are individually designed to be provided at such the one connector. And hence it becomes to be required in general a force as further larger in proportion to the number of pins. And then in a case where there is required for an operator to add such the force thereto as so larger that it cannot be inserted by hand thereinto, it becomes required therefor such as a special tool for insertion thereinto or an apparatus therefor. And hence it becomes to be decreased, a workability thereof, and then thereby causing an effect as negatively on to an efficiency on production of such as the motor vehicles or the like either. While, in a case where there is designed for the number of the pines therein to be decreased on the contrary thereto in order to suppress such the force for insertion thereinto, it cannot be responded such the needs for the connector to be as the multi way type.

And more specifically thereto in a case where there is made use of such a connector in which there is designed to be made use of a metallic terminal on which there is designed to be performed a plating of tin in particular, there becomes easier for such the tin that is plated on a surface thereof to be worn away as easily and then to be oxidized due to a slight vibration thereon. And hence there may be occurred a change in a state of contact of such the connector, and then there may be occurred a worsening of an electrical conduction thereof. And thus with taking into consideration of such the matter, it is not able to design for any space to be provided at between each of the male terminals therein and each of the corresponding female terminal therein. And hence there becomes to be required the force for insertion thereinto as further larger.

While, there is disclosed a technique as one example that there is designed to be provided a coating film layer on to a metal material for plating in which there is designed for a lead frame that there is designed to be performed a plating of tin thereto to be soaked into an aqueous solution that there is designed to be contained a polyoxyethylene alkyl ether sulfuric ester salt and/or an alkyl sulfo succinate as not less than one nature thereof (refer to the Japanese Patent Application Publication No. 2005-336554). And then in accordance with such the lead frame therein, it is regarded that it is possible to suppress an occurrence of any whisker on such the plating of tin thereto. Moreover, there is disclosed another technique to perform a process for a steel sheet with making use of an alkanethiol solution, that is electrogalvanized and then the same is cold rolled (refer to the Japanese Patent Application Publication No. 2005-240181). And then thereby being regarded that it becomes able to protect such the steel sheet from a corrosion of such as a rust or the like due to such as a salt water or the like. However, it is not clear regarding a performance of each of such the metal materials to be formed as a connector with making use thereof respectively.

Further, there are disclosed the other techniques to perform a process of plating on to a terminal of an electronic component and then to perform a treatment for a plated surface thereof by performing an application of a surface active agent or a solution of such the surfactant thereto as a processing agent in order to improve a wettability of a solder thereto (refer to the Japanese Patent Application Publication No. 2004-176179 and the Japanese Patent Application Publication No. 2004-323926). And then in accordance with such the technique therein, it becomes able to suppress an oxidation of a terminal part therein, and it becomes able to improve a wettability of such the solder thereto as remarkably as well, and hence it becomes able to improve a bondability with making use of such the solder and then a reliability thereof as remarkably for both thereof. However, it is not clear regarding such as a force for insertion or a property of sliding or the like with making use of such a connector that there are performed such the processes therefor. Furthermore, it is difficult to prevent completely a metal material that is performed such the processes from such as a discoloration on a surface thereof or a corrosion of the plating layer thereon. And, it is considered to be a cause thereof that there becomes to be bound such the surface active agent to such as a moisture content or an acidic substance or the like in an ambient atmosphere due to such the surface active agent as including a hydrophilic group, and then that there becomes to be occurring a reaction with the metal that is plated thereon.

And thus there has not established any technology by which it becomes able to realize an improvement of such as a property of a fretting resistance and a property of a corrosion resistance and the like together at a same time thereof, and therefore it is required for any solution to satisfy such the matters as soon as possible.

### DISCLOSURE OF THE INVENTION

Therefore, the present invention provides the following aspects.

(1) A fretting-resistance connector thereto comprises an organic coating that is formed of an organic compound which has an ether linkage group at least a part on a surface of an electrically conductive metal material.

(2) The fretting-resistant connector according to (1), wherein said organic compound in order to form said organic coating is formed of only said ether linkage group and a hydrophobic group.

(3) The fretting-resistant connector according to (2), wherein said hydrophobic group therein is formed of a hydrocarbon group.

(4) The fretting-resistant connector according to one of (1) to (3), wherein said connector is configured of a male terminal and a female terminal as not less than one for each thereof, and said organic coating is formed on to at least said part on said surface of said electrically conductive metal material that forms said male terminal.

(5) The fretting-resistant connector according to (4), wherein said male terminal comprises a part for connection in order to be connected said female terminal thereto, and said organic coating is formed on to at least a part on said surface of said electrically conductive metal material that forms said part for connection as well.

(6) The fretting-resistant connector according to one of (1) to (5), wherein a thickness of said organic coating is between 0.0001 μm and 0.1 μm.

(7) The fretting-resistant connector according to one of (1) to (6), wherein there is designed for said electrically conductive metal material to be provided an electrically conductive surface layer that is formed of tin, or gold, or silver, or copper, or an intermetallic compound of copper and tin, or an intermetallic compound of nickel and tin, or an intermetallic compound of tin and silver, or to be provided an electrically conductive surface layer that is formed of a metal composition in which there is designed for tin to be dispersed at a side of a surface of a layer that is formed of any one of said intermetallic compounds, on to an electrically conductive substance.

(8) A process for manufacturing the fretting-resistant connector, comprising the steps of: coating an ether compound or a solution in which said ether compound is included in a solvent on to a surface of an electrically conductive metal material; and preventing a coating film layer that is formed of said ether compound on to said surface of said electrically conductive metal material; or dispersing and then adsorbing said ether compound on to said surface of said electrically conductive metal material.

(9) The process for manufacturing the fretting-resistant connector according to (8), wherein there is processed for said ether compound to be formed of only an ether linkage group and a hydrophobic group.

(10) The process for manufacturing the fretting-resistant connector according to (8) or (9), wherein there is designed to be made use of a volatile solvent for said solvent, and there is processed for said solution in which said ether compound is included in said solvent as between 0.01 mass percent and fifty mass percent to coat on to said electrically conductive metal material.

(11) The process for manufacturing the fretting-resistant connector according to one of (8) to (10), wherein there is designed for said electrically conductive metal material to be formed by performing a process of punching and by performing a process of bending, after performing a process of coating said solution thereto, or with performing said process of coating said solution thereto.

The above and other aspects and advantages in accordance with the present invention will be further clarified by the following description, in reference to the drawings that are attached as properly therefor.

### BRIEF DESCRIPTION OF THE DRAWINGS

FIG. 1 is a cross sectional view exemplary showing a principal part of a connector regarding one embodiment in accordance with the present invention.

FIG. 2 is a diagrammatic perspective view exemplary showing a whole shape of a male terminal for the connector that is shown in FIG. 1.

FIG. 3 is a diagrammatic perspective view exemplary showing an internal structure of a female terminal for the connector that is shown in FIG. 1.

FIG. 4 is a cross sectional view exemplary showing with enlarging a cross section for a part of a metal material (Test sample material 4) that is produced in accordance with one example.

FIG. 5 is a lateral view showing an aspect of a test for slight sliding.

### BEST MODE FOR CARRYING OUT THE INVENTION

Hereinafter, a fretting-resistant connector in accordance with the present invention will be described in detail below.

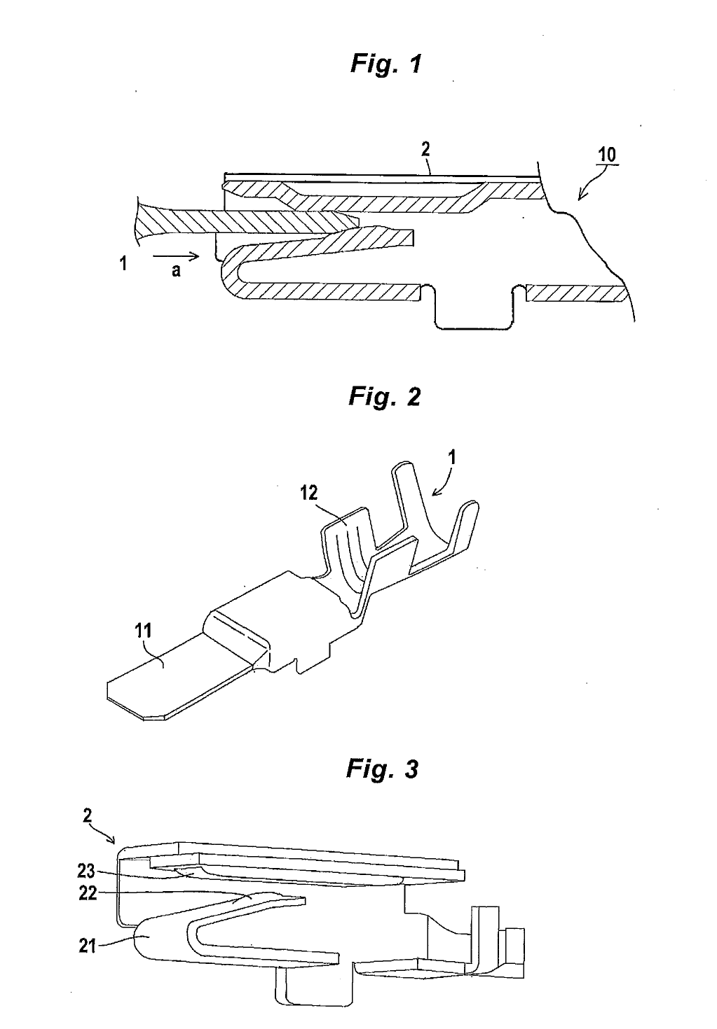

Here FIG. 1 is a cross sectional view for exemplary showing a principal part (a part for connecting thereto) regarding one embodiment of a fretting-resistant connector in accordance with the present invention. And, there is shown therein a connector (10) in accordance with the present embodiment as a state where a male terminal (1) therein and a female terminal (2) therein are on the way to be connected to each other. Moreover, there is inserted such the male terminal (1) into an inner part of such the female terminal (2) in a direction for insertion (a) from such the state thereof, and then thereby becoming the connector that is connected as firmly to therebetween.

FIG. 2 is a diagrammatic perspective view for exemplary showing a whole shape of the male terminal (1) therefor that is shown in FIG. 1. Moreover, such the male terminal (1) in accordance with the present embodiment comprises a tab (11) as a part for connection (a connecting part) to between a female terminal (2) therefor, and a wire barrel (12) as a part for jointing by pressing in order to perform a jointing by pressing with an electric wire. Further, there is designed for such the tab (11) to be formed as a flat plate shape, and then there is designed for the same with having an upper surface thereof and a lower surface thereof to be finished with such the individual surfaces as smooth respectively.

Still further, FIG. 3 is a diagrammatic perspective view for exemplary showing an internal structure of the female terminal (2) therefor that is shown in FIG. 1. And then there are designed for such the female terminal (2) and for the male terminal (1) that is mentioned above to be as connectable with each other, and there are designed therefor to be available to configure the connector therein, that are described above. Still further, there is designed for a connection mechanism part in the female terminal (2) for the male terminal (1) in accordance with FIG. 3 to be formed at an inner side of a part as a hollow box shape, and then there is designed therefor to comprise a ligulate piece (21) and a dimple (22) and also a bead (23) thereat.

Still further, there is designed for such the dimple (22) to be as a member of convex shape that is designed to be arranged on an upper part of the ligulate piece (21) therein, and then that there is designed therefor to be point contacted with a lower surface of the tab (11) therein at a period of the connection to the male terminal (1) therefor. Still further, there is designed for such the ligulate piece (21) therein to have a function as a spring in order to generate a contact pressure, that is to say, a pressure to push the dimple (22) toward the tab (11) therein. Still further, there is designed for the bead (23) therein to be as a member of convex shape as well, and then that there is designed therefor to be contacted to the upper surface of the tab (11) therein and then there is designed therefor to generate as effectively the contact pressure of which such the dimple (22) that is mentioned above forces toward the tab (11) therein.

Still further, in such the case of inserting and then connecting the male terminal (1) to the female terminal (2), there is designed for the tab (11) therein to be inserted into a space between the ligulate piece (21) therein and the bead (23) therein, that is shown in the cross sectional view of FIG. 1. Furthermore, there is designed for such the bead (23) therein to be contacted as slidable onto the upper surface of the tab (11) therein and there is designed for such the dimple (22) therein to be contacted as slidable onto the lower surface of the tab (11) therein as well in such the case thereof. And then at a period of inserting such the tab (11) thereinto completely, there is designed for the tab (11) therein to be contacted and held with being pressed against and at between such the bead (23) therein and such the dimple (22) therein under a state where each of such the members is contacted as strongly with the tab (11) respectively. And hence there is designed to be performed a connection as electrically between such the male terminal (1) therein and such the female terminal (2) therein as preferred thereto. That is to say, in accordance with the connector (10) regarding the present embodiment, there are designed for such the upper surface of the tab (11) at the side of the male terminal (1) therefor and for such the lower surface thereof at the side thereof to become the individual parts for a point of contact respectively, and meanwhile, there are designed for such the bead (23) at the side of the female terminal (2) therefor and for such the dimple (22) thereat on the contrary thereto to become the individual parts for a point of contact as well respectively. And thus it becomes possible to connect to each of such the members as electrically.

Here a connector in accordance with the present invention will not be limited to such the connector (10) in accordance with the embodiment that are shown in FIG. 1 through FIG. 3, and then there may be designed for such a connector to be as any embodiment if it is possible to connect a pair of terminals therefor to each other.

Moreover, it is available to design therefor to be provided the pair of the male terminal and the female terminal as a plurality of such the pairs therein, for example, it is able to design therefor to be provided the pairs of such the individual terminals therein as from one pair to 100 pairs thereof. And then it is able to mount such the connector on to a motor vehicle, as the connector for mounting on to the motor vehicle for example. Further, it becomes able to apply such the connector as preferred to a connector to be made use for a variety of usages in addition thereto, such as for an electrical device or for an electronic device or the like.

Furthermore, there is no limitation at all in particular regarding a size of the connector in accordance with the present invention. However, it is practical that there is designed for a connector as small in size for mounting on to a motor vehicle to have a length as approximately between five millimeters and fifty millimeters in a direction as longitudinal of a male terminal therefor or that of a female terminal therefor for example.

Here in accordance with the present invention, there is designed for the connector to comprise an organic coating that is formed of an organic compound which has an ether linkage group at least a part on a surface of an electrically conductive metal material, by performing a process of coating an ether compound or a solution in which such the ether compound is included in a solvent on to the surface of such the electrically conductive metal material.

And then it is desirable for such the organic compound in order to form the organic coating thereto to be formed of only the ether linkage group (—O—) and a hydrophobic group. That is to say, there is designed for such the organic compound that is formed of only the ether linkage group and the hydrophobic group not to include any group else than the ether linkage group nor the hydrophobic group, that is to say, any hydrophilic group of such as any hydroxyl group (—OH) or any carboxyl group (—COOH) or any amino group (—NH₂) or any sulfonic group (—SO₃H) or any mercapto group (—SH) or the like. In other words, there is designed for such the organic compound not to be as a surface active agent. Moreover, it is further desirable for such the hydrophobic group therein to be formed of a hydrocarbon group. Further, it may be available to design for the hydrocarbon group that is mentioned above to be formed of either one of an aliphatic hydrocarbon group or an aromatic hydrocarbon group. Furthermore, there is designed for such the organic compounds as preferred thereto to be hydrophobic as a whole thereof. And then by being designed to be provided as such the organic coating at least the part on the surface of the electrically conductive metal material, it becomes able to obtain the advantages as extremely in particular for such as an improvement of the property of the fretting resistance and an improvement of the property of the corrosion resistance and the like, such as a prevention of the corrosion in particular due to a moisture content in an ambient atmosphere and due to a substance that becomes to have an acidity or to have an alkalinity at a time when such the substance becomes to be dissolved into such an aqua content therein or the like.

Moreover, it may be available to design for the ether compound or for the solution thereof that are mentioned above to be performed the process of coating on to a whole of the connector or on to a part thereof. And then in the case where there is designed for either one thereof to be performed on to the part thereof, it is available to give such as an embodiment in which there is designed therefor to be performed the process of coating on to either one of a male terminal or a female terminal, or another embodiment in which there is designed therefor to be performed the process of coating on to only a connection part of each of terminals (for example, it is available to give an example of such as the tab (11) in the male terminal in FIG. 2 or the ligulate piece (21) and the bead (23) in the female terminal that are shown in FIG. 3 in reference to the connector (10) in accordance with the embodiment that is described above), or the like. Further, it may be available to determine as properly whether to perform the process of coating on to the whole thereof or to perform the process of coating on to the part thereof, with taking into consideration of such as a usage of such the connector, or a throughput on the process of coating thereto, or an area and a shape of the part that is required in particular for such the process of coating thereto, or the like. And then from a point of view of obtaining an improvement on the property of the sliding in particular, it is further preferable to design for a side of the male terminal (1) therefor to be formed such the organic coating. Still further, it becomes able to obtain an improvement on the property of the fretting resistance of the tab (11) therein that is receiving a contact pressure, by designing in particular for such the tab (11) in the male terminal (1) therefor to be provided such the organic coating, that is designed to be as the connecting part for between such the male terminal (1) therefor and the female terminal (2) therefor.

Still further, there is no limitation at all in particular regarding a thickness of such the organic coating in such the case thereof. However, it is desirable to design therefor to be as between 0.0001 μm and 0.1 μm from a point of view of suppressing an increase of the contact resistance of therebetween and from a point of view of any smudge on to the whole of the connector due to such the organic coating, or it is further preferable to design therefor to be as between 0.0001 μm and 0.01 μm. While, in a case where there is designed for the thickness of such the organic coating to be as excessively thinner on the contrary thereto, it is not able to function as effectively the suppressing of the increase of the contact resistance thereof. Furthermore, in a case where there is designed therefor to be as excessively thicker on the contrary thereto, there becomes to be adhered the organic compound that configures such the organic coating on to the whole of the connector including the side of the female terminal (2) due to such as a vibration or the like after performing a mounting thereof. And hence there becomes to be the smudge thereto, and then thereby occurring an anxiety regarding an effect as negatively on to other parts and components.

Moreover, it is desirable to design for the electrically conductive metal material that is mentioned above to be provided an electrically conductive surface layer on to an electrically conductive substance. Further, there is no limitation at all in particular regarding the electrically conductive substance therein that is mentioned above if it is available to design therefor to be made use as a substance for such the electrically conductive metal material. And then it is available to give an example of a material in order to form such the electrically conductive substance therein, such as copper (Cu) or an alloy of the same, or iron (Fe) or an alloy of the same, or nickel (Ni) or an alloy of the same, or aluminum (Al) or an alloy of the same, or the like.

Still further, there is no limitation at all in particular regarding a shape of such the electrically conductive substance therein if it is available to design therefor to have a shape so that it is available to be made use for a material for an electrical device and for an electronic device, such as a plate shape or a rod shape or a wire shape or a tubular shape or a bar shape or an atypical bar shape or the like. Still further, there is no limitation at all in particular regarding a size of such the electrically conductive substance therein. However, in a case where there is designed therefor to be a substance for a terminal with having a plate shape for example, it is desirable to design for a coil that is rolled as a hoop shape to have a width as approximately between ten millimeters and thirty millimeters from a practical point of view, and it is desirable to design therefor, to have a thickness as approximately between 0.05 mm and 0.8 mm as well. Furthermore, regarding a width of the material therefor, it is required to perform a process of manufacturing with making use of the material that has a width as wider than such the width thereof that is mentioned above in order to obtain an improvement of efficiency in a case of manufacturing a metal material therefor. And then it may be available to obtain a material with having a width that is required therefor, by performing a process of cutting thereafter for such the material.

Moreover, it is desirable to design for the electrically conductive surface layer that is mentioned above to be a layer that is formed of any one which is selected from the following group of tin, gold, silver, copper, an intermetallic compound of copper and tin, an intermetallic compound of nickel and tin, and an intermetallic compound of tin and silver, or to be a layer which is comprised of a metal composition in which there is designed for tin to be dispersed on to a side of a surface of the layer of any one of such the intermetallic compounds that are mentioned above. And then in particular it is further preferable to design therefor to be the layer that is formed of any one which is selected from tin, the intermetallic compound of copper and tin, silver, and the intermetallic compound of silver and tin in such the above mentioned group thereof.

Further, regarding such tin and the intermetallic compound of tin therefor, it may be available to give an example of such as tin, an alloy of tin and copper, an alloy of tin and silver, an alloy of tin and zinc, an alloy of tin and lead, an alloy of tin and silver and copper, an alloy of tin and indium, an alloy of tin and bismuth, an alloy of tin and silver and bismuth, and the like. And then it is further desirable to make use of tin, the alloy of tin and copper, the alloy of tin and silver, the alloy of tin and lead, and the alloy of tin and zinc among such the above mentioned examples thereof, or it is further preferable to make use of tin and the alloy of tin and copper. Still further, it is available to make use of such as any other intermetallic compound of tin and any other metal or the like as well in accordance with the present invention, in which such the other metal has an atomicity as larger than the atomicity of tin in such the intermetallic compound (such as an Ag₃Sn or an Cu₆Sn₅ or the like). Still further, it is desirable to design a content of Sn therein to be as not lower than fifty mass percent (such as the Cu₆Sn₅ or the like). Furthermore, it is desirable to design a material therefor to contain Sn therein as not lower than fifty mass percent (50 at %) by a ratio of atomicity therebetween and as not lower than fifty mass percent (50 mass %) by a ratio of mass therebetween as well for a whole of such the surface layer thereon (as a sum of such the alloy of Sn and the other alloy of Sn and the pure Sn therein), with taking into consideration of such as a manufacturing cost therefor or the like in a case where there is designed to make use of an alloy of Sn and precious metal, such as an alloy of Sn and Ag or the like.

Moreover, it is available to design as well for an intermediate layer to be provided as properly in between the electrically conductive substance and the electrically conductive surface layer that are mentioned above.

Further, it is available to give an example of such the intermediate layer therein, such as nickel (Ni) or an alloy of the same, cobalt (Co) or an alloy of the same, iron (Fe) or an alloy of the same, copper (Cu) or an alloy of the same, or the like. And then it is further preferable therefor to make use of nickel in the above mentioned group thereof.

Still further, it is desirable to design for an intermediate layer in a case where there is designed to be provided such the intermediate layer therein to be formed with having the number as two layers for such the intermediate layer therein, and then it is desirable to design for such the intermediate layers therein that are provided as two layers to be formed as a layer that is designed to be formed of nickel or an alloy of the same, and then therefor to be formed as a layer that is designed to be formed of copper or an alloy of the same, in order as the one after the other from a point of view of an upper side of the electrically conductive substance. This is because it is able to perform a formation of a compound of tin and copper as easier on to a surface layer thereon, due to the tin in such the surface layer thereon having a property as easily reacting with the copper therein and then easily generating such the compound therein, by designing for such the intermediate layers therein to be performed the formation of the layer that is designed to be formed of nickel or the alloy of the same, and then therefor to be performed the formation of the layer that is designed to be formed of copper or the alloy of the same, in order as the one after the other from the point of view of the upper side of the electrically conductive substance. Still further, it may be available to give an example of such the intermetallic compound to be formed therein, such as the Cu₆Sn₅ or a Cu₃Sn or the like. And then it is able to perform a control of such as a thickness of such the compounds or a state of formation thereof or the like, by performing a control of a coating thickness of such the intermediate layers therein and that of the layer of tin therein in a stoichiometric manner therefor. Furthermore, it may be available to design for a layer of pure tin to be remained therein in place of designing for a most surface layer to be formed as a layer of an alloy of tin as completely, by performing a process of coating of such the layer of tin as thicker than that in accordance with the stoichiometry therefor.

Moreover, it may be available to design for such the electrically conductive surface layer and for such the intermediate layer therein to be provided on a whole of a face of the electrically conductive substance therein, or it may be available to design for both thereof to be provided at a part thereof, or it may be available to design for both thereof to be adjusted as properly a state of a coating thereon in response to a requirement therefor as well.

Furthermore, there is no limitation at all in particular regarding a thickness of such the electrically conductive surface layer that is designed to be formed on to such the electrically conductive substance therein, however, it is desirable to design therefor to be as between 0.1 μm and 5 μm with including an intermediate layer in a case where there is designed to be provided such the intermediate layer therein, from a practical point of view.

Moreover, there is no limitation at all in particular regarding a rate of content of both of metals in a case where there is designed for the electrically conductive surface layer to be as a layer of an intermetallic compound of copper and tin. However, it is desirable to design for the tin therein to be as between one mol percent and fifty mol percent for example. Further, there is no limitation at all in particular regarding a rate of content of both of metals in a case where there is designed therefor to be as a layer of an intermetallic compound of tin and silver. However, it is desirable to design for the silver therein to be as between one mol percent and seventy mol percent for example. Furthermore, there is no limitation at all in particular regarding a rate of content of tin to be dispersed in a case where there is designed therefor to be as a layer of a metal composition in which there is designed for such the tin to be dispersed into either one of the intermetallic compounds that are mentioned above. However, it is desirable to design for such the tin to be dispersed thereinto to be as between fifty mol percent and ninety-five mol percent for a total of such the metal composition in the surface layer thereof.

Here in accordance with the present invention, it is desirable to provide an organic coating, that is designed to be formed of an ether compound which has an ether linkage group, on to a surface of an electrically conductive metal material. Moreover, there is designed for such the organic coating to have the ether linkage group and then thereby performing a physical adsorption or a chemical absorption for tin (Sn) or for an alloy of the same thereto. And hence it becomes able to function as effectively a function of such the organic coating that has both a lubricating ability, the same becomes to be superior in a property of sliding, and then it becomes able to reduce a force for insertion into a connector as well that is designed to be as the multi way type for example. Further, it becomes able to improve a property of a corrosion resistance for an electrical device and for an electronic device, and it becomes possible to protect a surface of a metal or a plating surface from occurring an oxidation (a rust) due to a function to block out such as an aqua or an oxygen or the like. Still further, it becomes possible to improve as rapidly the property of the fretting resistance thereof. Still further, it becomes able to be superior in the property of sliding and to have the property of the corrosion resistance thereof as required therefor as well, by being designed to have a property of wear and abrasion resistance thereof even under an environment with an application of a load of approximately 1 N/mm² as relatively higher.

Still further, regarding the electrically conductive metal material in accordance with the present invention, it becomes able to obtain an electrical conduction because there is designed for the organic coating that is designed to be formed with having a layer thickness of such the organic coating in order not to occur any insulation therethrough at a period of contacting as a terminal for example, even in the case where there is designed to be provided such the organic coating that is mentioned above.

Still further, there is no limitation at all in particular regarding a designing for the organic coating to coat the electrically conductive metal material as how much degree of an area thereof in the case where there is designed for such the organic coating to be formed on to the surface of such the electrically conductive metal material. And then by designing such the organic coating to be formed in order to coat as not less than forty percent of an area of a surface of a connection part (of such as a tab (1) or the like) for example, it becomes able to obtain the property of the fretting resistance thereof to be as further preferred therefor. While, it is not able to function as effectively a suppressing of an increase in the contact resistance thereof in a case where there is designed for a rate of coverage for such the area thereof as excessively lower on the contrary thereto. And therefore it is further preferable therefor to be as between eighty percent and a hundred percent as completely coated thereto.

Here, it is able to give an example of such as an ether compound with having an atomicity of carbon therein as between five and forty or the like for such the organic compound which has the ether linkage group as that is mentioned above. And then it is further preferable therefor to be as an ether compound with having an atomicity of carbon therein as between six and thirty. Moreover, it is able to give an example an ether compound that is designed to be formed of only an ether linkage group and to be formed of a hydrophobic group for such the ether compound therein, such as a dipropyl ether or an allyl phenyl ether or an ethyl isobutyl ether or an ethylene glycol diphenyl ether or a pentaphenyl ether or an alkyl (such as a nonyl or an eicosyl or the like) diphenyl ether or the like. Further, it is further preferable therefor to be as an ether compound with having a molecular weight therein as not lighter than one hundred. And then thereby being possible to obtain an organic coating that becomes to have a boiling point as relatively higher and then to be superior in a property of heat resistance as well, and then thereby being possible to function an advantage as further superior therein. Still further, it may be available to design for such the organic compound that has the ether linkage group as that is mentioned above to further contain a nitrogen atom and a sulfur atom if such the organic compound has a formula and a structure as a total thereof by which there is not indicate any property as hydrophilic at all.

Still further, it is desirable to design for such the ether compound that is mentioned above in accordance with the present invention to be formed of a non sulfur ether compound in which there is not contained any atom of sulfur therein. And then it is further desirable therefor to be designed as a hydrocarbon either compound containing nitrogen that is formed of an atom of carbon, an atom of oxygen, an atom of hydrogen and an atom of nitrogen. Or, it is further preferable in particular therefor to be designed as a hydrocarbon either compound (an aliphatic either compound or an aromatic either compound) that is formed of an atom of carbon, an atom of oxygen and an atom of hydrogen. Furthermore, it is further preferable for such the hydrocarbon either compound to be as an either compound in which there is not designed to contain any atom of oxygen at all therein except for such the either linkage group therein, for which there is given the example that is mentioned above. And thus by making use of such a substance in which there is not designed to contain any atom of sulfur therein at all in such a manner, it becomes preferred from a point of view of no occurrence of such as a corrosion due to sulfidation or the like in an electrical device or in an electronic device at all.

Here there is designed for the connector in accordance with the present invention to be formed by coating such the either compound that is mentioned above or a solution in which there is designed for such the either compound to be contained in a solvent on to a surface of an electrically conductive metal material and then by providing a coating film layer that is formed of such the either compound, or by performing a dispersion and then an absorption of such the either compound thereto. Moreover, it is desirable for such the solvent that is mentioned above to be as a volatile solvent and then to apply a solution in which there is designed for the ether compound that is mentioned above with having a mass percent of between 0.01 and fifty into such the volatile solvent on to the electrically conductive metal material. And then it is desirable for such the electrically conductive metal material to be formed by performing a process of punching and by performing a process of bending, after performing a process of coating such the solution thereto that is mentioned above, or with performing the process of coating the solution thereto. Further, as mentioning regarding a method as more specifically thereto for applying such the specified ether compound that is mentioned above thereto, it may be available to make use of such the specified ether compound that is mentioned above as being mixed with an oil for a press working (a lubricating oil). Here it can be mentioned that there is often made use of a kerosene for the oil for the press working, that is the volatile solvent and in which a principal component is an alkane that has an atomicity of carbon as between nine and fifteen in general and in which there is not contained any ether compound at all. And then it is able to design to dissolve such the specified ether compound that is mentioned above into such the kerosene. Still further, it becomes able to perform the process of applying such the ether compound that is mentioned above thereto as well in a case where there is designed for such the dissolved solution to be made use for such the oil for the press working and then there is performed the process of punching and performed the process of bending for such the metal material that is mentioned above. That is to say, it becomes able to perform the application of such the ether compound that is mentioned above on to the surface of the connector without being required any other process of coating thereto.

Still further, it is desirable for a concentration of the ether compound that is mentioned above in the solution for coating thereto to be as between 0.01 mass percent and fifty mass percent. Or, it is further preferable therefor to be as between one mass percent and ten mass percent from a point of view of such as a process of working for coating thereto or the like. While, in a case where there is designed for such the concentration thereof to be as excessively lower therein on the contrary thereto, it is not able to form any organic coating thereto by which it is able to function as effectively the suppression of the increase in the contact resistance thereof. While, in a case where there is designed therefor to be as excessively higher therein on the contrary thereto, there becomes to be remained substances of the organic component as more thereon at a period of performing such as the process of coating thereto or the like due to the volatile solvent as less therein. And hence there becomes to be adhered such the organic component as a larger amount on to a whole of the connector including the side of the female terminal (2) therein, and then there becomes to be a smudge thereon. And therefore it becomes to be anxious about an effect as negatively on to other parts and components therein. Still further, it may be available to give an example of the volatile solvent to be made use for such the period of the process therefor in place of the kerosene that is mentioned above, such as a toluene, an acetone, a trichloroethane, a synthetic solvent as a commercial product (the NS CLEAN 100W for example) or the like. Still further, it is desirable for the solvent that is mentioned above to contain an impurity as hydrophilic with having a content of a level as unavoidable from a point of view of ensuring the hydrophobic property of the organic coating thereto, and then it is desirable therefor to be designed for such the impurity as hydrophilic in order not to be remained in the organic coating in accordance with the present invention. Still further, it is further preferable to design such the solvent as more specified thereto to be as a solvent in which there is not designed to be contained any hydrophilic group at all in a molecule thereof, and in which there is not designed to be contained any impurity as hydrophilic at all either.

Still further, it may be available to design for the process of the application of such the organic coating thereto to perform a process of forming an organic film layer of one type as not less than two times thereto, or to perform a process of forming an organic film layer as not less than two times thereto with making use of a mixed liquor that is formed of ether compounds as not less than two types thereof, or to perform a process of forming such the organic film layers as one after the other. Still further, it is further preferable to design to perform such the process of forming therefor as not more than three times thereof from a point of view of taking into consideration of such as the number of processes therefor or a manufacturing cost thereof or the like.

Still further, there is designed for such the ether compound that is mentioned above to be dissolved into a solvent as a variety thereof without being required such as performing an agitation as excessively thereof or performing a heat treatment as excessively thereof or the like. And therefore it becomes able to select a solvent as properly in response to such as a nature of the metal material therefor or a requirement regarding each of the processes thereof or a usage of the connector or the like, and then it becomes able to make use thereof. And then thereby obtaining a generality as abundant therein.

Still further, there is designed for the ether group in such the ether compound that is mentioned above to be adsorbed as chemically on to the surface of the metal therefor. And hence it becomes able to obtain the coating film layer that has a preferred state thereof or to obtain a state of dispersion and adsorption as excellently to be remained on the surface of the metal therefor, without being flowed down as easily with such as the solvent or the like at the period of the process of such the application thereof or after such the process thereof. And then thereby becoming able to function as effectively the function of such as the organic coating thereto that has both the lubricating ability as well, to become superior in property of sliding, and to suppress the force for insertion thereinto as lower even for a connector that is designed to be as a multi way type as well.

Furthermore, it becomes possible to maintain the functions of such the ether compound that is mentioned above as superior therein even after performing a process of press working on such as a male terminal or of a female terminal or the like that brings a transformation as remarkably as well, because of an adsorptive power of such the ether compound that is mentioned above on to the surface of the metal therefor. And therefore it becomes able to perform the process of the application of such the ether compound that is mentioned above thereto before performing the process of press working thereof or at the same time thereof, that is described above. And then thereby obtaining a degree of freedom regarding the processes thereof to be enhanced as sharply higher comparing to a substance that it is possible to perform an application thereof only after performing the process of working therefor.

Here the property of the fretting resistance thereof that is described above means that there is designed to suppress as effectively the fretting phenomenon that will be described below. Such the above mentioned fretting phenomenon is the phenomenon that a plating layer as a soft layer on a surface of a terminal becomes to be worn away and to be oxidized and then to be a abrasion powder that has a specific resistance as higher, due to a slight sliding that is generated on between the contact faces of a metal material, such as the individual terminals or the like therein, because of such as a vibration thereon or variation of a temperature thereof or the like. And then due to such the phenomenon, there may become to be occurred a decrease in the electrical connection of between each of the terminals therein.

Here with making use of the connector in accordance with the present invention, in a case of a connector therein for which there is designed to be performed a plating of tin for example, and then even in a case where there is designed for a force to be decreased which is for putting a tab part of a male terminal thereinto due to a dimple part of a female terminal and a bead part thereof by performing such as a designing of reducing a distance between such the dimple part of the female terminal and such the bead part thereof or the like, it becomes able to prevent from such the fretting phenomenon that it is easier to be occurred in such the case thereof, because there becomes to be improved the property of the fretting resistance thereof that is described above. And therefore it becomes able to obtain the function of the property of sliding to be further excellent that the specified either compound which is mentioned above has, and it becomes able to obtain a function of reducing the resistance against the insertion thereinto as well due to performing the decrease in the force to put the male terminal thereinto. And thus it becomes able to reduce the force for the insertion of the connector as the multi way type as sharply.

Moreover, in a case where there is performed a production of metal material with making use of a hard layer of an intermetallic compound of copper and tin to be as a surface layer and with making use of a layer in which there is designed for tin to be dispersed into such the intermetallic compound of copper and tin as well, and then thereafter in a case where there is performed a process of working therefor to be a terminal by performing a setting as properly of such as a condition of a process of bend working thereof, a condition of a process of projecting thereof, and the other conditions thereof, there may be occurred a case where there becomes to be cracked as compulsively such the hard plating layer that is mentioned above. And then in such the case thereof, it becomes able to assist in accordance with the present invention regarding a soaking of the ether component or of the solution in which there is designed for such the ether component to be contained in the solvent, by performing the application of such the component or the solution thereof thereto in the period of the process of press working therefor or after performing such the process of press working therefor. And therefore it becomes possible to prevent from the occurrence of the fretting phenomenon as further effectively even in a case where a contact part therein is under a state that the same becomes to be worn out as easier due to the vibration of the terminal or the heat thereof after performing the process of the application of such the ether compound that is mentioned above.

Further, with making use of such the fretting-resistant connector that comprises the male terminal and the female terminal in accordance with the present invention, it becomes able to obtain the following functions and the advantages that it becomes able to insert and then to connect to each of between the pair of the terminals which is mentioned above or the pairs thereof as a plurality thereof with the force as weaker for the insertion thereinto for all together at the same time thereof, that it becomes able to obtain the property of the fretting resistance as superior therein as well, and that it becomes possible to maintain the electrical conduction of therebetween as excellently and as extending over a long period of time even in the case where such the contact part in the pair of the terminals which is mentioned above becomes to be worn out due to such as the slight vibration thereof or the like.

Furthermore, by making use of the process for manufacturing such the connector in accordance with the present invention, it becomes able to manufacture as efficiently such the fretting-resistant connector that becomes to have the properties as superior therein which is described above without being required any complicated process therefor.

### EXAMPLES

Hereinafter, the present invention will be described in further detailed below, in reference to each of the following Examples, however, the present invention will not be limited to each of such Examples.

### Example 1

### Test Sample Material 1

In the first instance there is performed the following process of removing a grease from a bar material of copper which has a thicknes of approximately 0.25 mm, and then thereafter there is performed a process of acid cleaning thereof. Moreover, there is performed thereafter a production of a layered body by plating by performing a process of an electroplating of Cu and then of Sn as a layered formation in such order on to such the bar material of the alloy of copper that is mentioned above. Here each of such a condition for plating each of the metals thereto is shown as below.

(A) Plating of Cu

(A-1) Composition of a plating bath

| CONSTITUENT | CONCENTRATION |
|---|---|
| Sulfate of copper | 180 g/L |
| Sulfuric acid | 80 g/L |

(A-2) Temperature of the bath: 40° C.

(A-3) Density of electricity: 5 A/dm²

(A-4) Thickness of the plating: 0.3 μm

(B) Plating of Sn

(B-1) Composition of a plating bath

| CONSTITUENT | CONCENTRATION |
|---|---|
| Tin II sulfate | 80 g/L |
| Sulfuric acid | 80 g/L |

(B-2) Temperature of the bath: 30° C.

(B-3) Density of electricity: 5 A/dm²

(B-4) Thickness of the plating: 0.8 μm

Here regarding each of the thicknesses that are mentioned above, it is able to change by performing a control of an amount of time for each of the processes of plating thereof respectively. And, this matter is the same for each of Test sample materials from 2 through 4 that will be described in detail below. Next, there is performed a process of a heat treatment therefor with an amount of time for seven seconds at a temperature of approximately 740° C. for an inner side of a reflow furnace. And thus it becomes able to obtain the metal material for an electrical device or for an electronic device (Test sample material 1), in which there are formed a layer of pure Sn and then an alloy layer of Cu—Sn in such order from a most surface thereof.

### Test Sample Material 2

In the first instance there is performed the following process of removing a grease from a bar material of copper which has a thickness of approximately 0.25 mm, and then thereafter there is performed a process of acid cleaning thereof. Moreover, there is performed thereafter a production of a layered body by plating by performing a process of an electroplating of Ni and of Cu and then of Sn as a layered formation in such order on to such the bar material of the alloy of copper that is mentioned above. Here each of such a condition for plating each of the metals thereto is shown as below.

(A) Plating of Ni

(A-1) Composition of a plating bath

| CONSTITUENT | CONCENTRATION |
|---|---|
| Nickel amiosulfonate | 500 g/L |
| Boric acid | 30 g/L |

(A-2) Temperature of the bath: 60° C.

(A-3) Density of electricity: 5 A/dm²

(A-4) Thickness of the plating: 0.5

(B) Plating of Cu

(B-1) Composition of a plating bath

| CONSTITUENT | CONCENTRATION |
|---|---|
| Sulfate of copper | 180 g/L |
| Sulfuric acid | 80 g/L |

(B-2) Temperature of the bath: 40° C.

(B-3) Density of electricity: 5 A/dm²

(B-4) Thickness of the plating: 0.3 μm

(C) Plating of Sn

(C-1) Composition of a plating bath

| CONSTITUENT | CONCENTRATION |
|---|---|
| Tin II sulfate | 80 g/L |
| Sulfuric acid | 80 g/L |

(C-2) Temperature of the bath: 30° C.

(C-3) Density of electricity: 5 A/dm²

(C-4) Thickness of the plating: 0.8 μm

Next, there is performed a process of a heat treatment therefor with an amount of time for seven seconds at a temperature of approximately 740° C. for an inner side of a reflow furnace. And thus it becomes able to obtain the metal material for an electrical device or for an electronic device (Test sample material 2), in which there are formed a layer of pure Sn and then an alloy layer of Cu—Sn and then a layer of Ni in such order from a most surface thereof.

### Test Sample Material 3

In the first instance there is performed the following process of removing a grease from a bar material of copper which has a thickness of approximately 0.25 mm, and then thereafter there is performed a process of acid cleaning thereof. Moreover, there is performed thereafter a production of a layered body by plating by performing a process of an electroplating of Ni and of Cu and then of Sn as a layered formation in such order on to such the bar material of the alloy of copper that is mentioned above. Here each of such a condition for plating each of the metals thereto is shown as below.

(A) Plating of Ni(A-1) Composition of a plating bath

| CONSTITUENT | CONCENTRATION |
|---|---|
| Nickel amiosulfonate | 500 g/L |
| Boric acid | 30 g/L |

(A-2) Temperature of the bath: 60° C.

(A-3) Density of electricity: 5 A/dm²

(A-4) Thickness of the plating: 0.5

(B) Plating of Cu

(B-1) Composition of a plating bath

| CONSTITUENT | CONCENTRATION |
|---|---|
| Sulfate of copper | 180 g/L |
| Sulfuric acid | 80 g/L |

(B-2) Temperature of the bath: 40° C.

(B-3) Density of electricity: 5 A/dm²

(B-4) Thickness of the plating: 0.8 μm

(C) Plating of Sn

(C-1) Composition of a plating bath

| CONSTITUENT | CONCENTRATION |
|---|---|
| Tin II sulfate | 80 g/L |
| Sulfuric acid | 80 g/L |

(C-2) Temperature of the bath: 30° C.

(C-3) Density of electricity: 5 A/dm²

(C-4) Thickness of the plating: 0.3 μm

Next, there is performed a process of a heat treatment therefor with an amount of time for seven seconds at a temperature of approximately 740° C. for an inner side of a reflow furnace. And thus it becomes able to obtain the metal material for an electrical device or for an electronic device (Test sample material 3), in which there is formed an alloy layer of Cu—Sn for a most surface thereof.

### Test Sample Material 4

In the first instance there is performed the following process of removing a grease from a bar material of copper which has a thickness of approximately 0.25 mm, and then thereafter there is performed a process of acid cleaning thereof. Moreover, there is performed thereafter a production of a layered body by plating by performing a process of an electroplating of Ni and of Cu and then of Sn as a layered formation in such order on to such the bar material of the alloy of copper that is mentioned above. Here each of such a condition for plating each of the metals thereto is shown as below.

(A) Plating of Ni

(A-1) Composition of a plating bath

| CONSTITUENT | CONCENTRATION |
|---|---|
| Nickel amiosulfonate | 500 g/L |
| Boric acid | 30 g/L |

(A-2) Temperature of the bath: 60° C.

(A-3) Density of electricity: 5 A/dm²

(A-4) Thickness of the plating: 0.5 μm

(B) Plating of Cu

(B-1) Composition of a plating bath

| CONSTITUENT | CONCENTRATION |
|---|---|
| Sulfate of copper | 180 g/L |
| Sulfuric acid | 80 g/L |

(B-2) Temperature of the bath: 40° C.

(B-3) Density of electricity: 5 A/dm²

(B-4) Thickness of the plating: 0.8 μm

(C) Plating of Sn

(C-1) Composition of a plating bath

| CONSTITUENT | CONCENTRATION |
|---|---|
| Tin II sulfate | 80 g/L |
| Sulfuric acid | 80 g/L |

(C-2) Temperature of the bath: 30° C.

(C-3) Density of electricity: 5 A/dm²

(C-4) Thickness of the plating: 0.5 μm

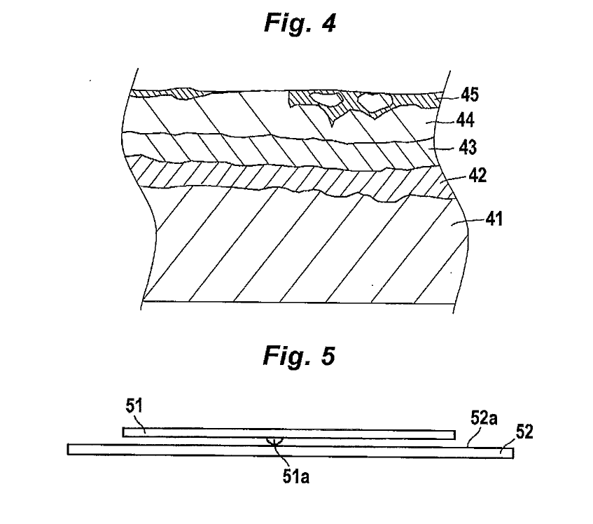

Next, there is performed a process of a heat treatment therefor with an amount of time for seven seconds at a temperature of approximately 740° C. for an inner side of a reflow furnace. And thus it becomes able to obtain the metal material for an electrical device or for an electronic device (Test sample material 4), in which there is designed for pure Sn to have a state that is dispersed into an alloy layer of Cu—Sn for a most surface thereof. Here there is shown a cross sectional view in FIG. 4 for exemplary showing with enlarging a cross section for a part of such Test sample material 4. And, in accordance with FIG. 4, the number (41) designates the bar material of copper as the electrically conductive base material therein, the number (42) designates the layer of nickel therein, the number (43) designates the layer of copper therein, the number (44) designates the layer of the intermetallic compound of copper and tin therein, and the number (45) designates the tin that is dispersed into the layer of the intermetallic compound of copper and tin (44) therein, respectively.

Moreover, there is performed a production of Test sample material 5, that is designed to be as a material in which there is designed for a layer of solid solution body of nickel and tin to be formed on a surface thereof and in which there is designed for copper to be as an electrically conductive base material therefor, as the other Test sample material. Further, there is performed a production of Test sample material 6, that there is designed for an intermetallic compound of silver and tin to be formed on a surface thereof in order to exist Ag₃Sn and Sn together at an inner side of a surface layer thereof as more specifically thereto, and then that there is designed for a ratio of atomicity of the Sn therein to be as not lower than fifty percent in a total of such the surface layer thereof, that there is designed for the ratio of atomicity of the Sn therein to be as fifty-one percent for such the sample material, in which there is designed for such the layer therein to contain such the Sn therein with having a ratio of mass thereof to be as approximately 53.4 mass %, and in which there is designed for copper to be as an electrically conductive base material therefor. Still further, there is performed a preparation of Test sample material 7, that is designed to be as a material in which there is designed for a layer of gold to be formed on a surface thereof and in which there is designed for copper to be as an electrically conductive base material therefor. Furthermore, there is designed for each of the thicknesses of such the individual electrically conductive base material therefor to be as approximately 0.25 mm respectively.

(Test for Slight Sliding)

Next, there is performed an evaluation by examining a test for slight sliding in order to determine the property of the fretting resistance regarding each of Test sample materials 1 through 7 that are described above. Here there is designed for such the test for slight sliding that is mentioned above to be examined as below.

That is to say, there is performed a preparation of the metal materials as one pair of an indent (51) and a plate (52) that are shown in FIG. 5 in the first instance, that there is provided a projected part of hemispheric shape (51a) which has a radius of curvature as approximately 1.8 mm with having an outside surface of the projected convex part thereon to be as a most outer surface layer thereof, and that the metal material (52) has a most outer surface layer (52a). Moreover, there is performed a process of cleaning for removing any grease from both of such the materials, and then thereafter there is contacted to therebetween with a contact pressure of 3 N approximately therefor. Further, there is performed a sliding for going and coming back the both of such the materials with a distance for sliding as approximately 30 μm under an environment at a temperature of 20° C. and with a humidity of 65% approximately, with a state thereof to be soaked a lubricating oil thereinto that will be described in detail later. Still further, there is flowed a constant electrical current of approximately 5 mA with applying an open circuit voltage of approximately 20 mV to between the metal material (51) and the (52). Still further, there is measured a fall of voltage at the period of sliding therebetween by making use of a four terminal method, and then there is evaluated the variation of the electrical resistance thereof for every one second. Here there is shown a value of the contact resistance before performing the test for slight sliding (an initial value) and a maximum value of the contact resistance at the period of performing such the test for slight sliding (a maximum value) in the following Table with distinguishing into each of groups as “∘ (GOOD)” or “Δ (ACCEPTABLE)” or “x (NO GOOD)” that will be described in detail later. Still further, there is performed such the movement of going and coming back with a frequency of approximately 3.3 Hz.

Moreover, there are made use of the individual Test sample materials from 1 through 7 for a material of the indent (51) that is for the evaluation thereof, and then there are made use of such the individual materials after performing a cutting to be a dimension of forty millimeters by ten millimeters and then performing a working of projection therefor respectively. Further, there are made use of the samples that are individually cut out from the individual Test sample materials from 1 through 7 for a side of the plate (52) to have a dimension of forty millimeters by nineteen millimeters respectively. Still further, there is performed a preparation of each of the lubricating oils in which there is dissolved a compound that has an ether linkage group into a kerosene as the volatile solvent respectively. Next, there is combined each of the test sample materials with the indent and with the plate respectively. Still further, there is performed an application of each of the lubricating oils that are mentioned above or together with each of the ether compounds that are shown in the following Table to each of the test sample materials that are mentioned above by making use of a felt to palm as going and coming back just one time in which there is soaked each of such the oils respectively. And thus there is performed a production for each of the test sample bodies in which there is combined each of the test sample materials with each of the corresponding lubricating oils or each of the corresponding ether compounds respectively, that are shown in Table 1 through 6. Still further, there is designed for a concentration of each of the ether compounds therein to be as five mass percent, and there is designed for each of the coating film layers therein to have a thickness of approximately 0.001 μm respectively.

Still further, there is performed a production of a test sample body in a case where there is changed a thickness of the organic coating therein that is shown in FIG. 7, there is performed a production of a test sample body in a case where there is changed a content of the ether compound in the volatile solvent that is shown in FIG. 8, respectively.

Still further, there is performed a contact between the projected part on each of the test sample bodies that are performed the preparation therefor in such the manner and the plate part therein by adding a force of 3 N, that is described as above. And then there is performed an observation and then a confirmation whether or not occur any increase in the contact resistance thereof at a period of the slight sliding by the number of times of 10000 with applying continuously a relative displacement that has a distance for slight sliding of approximately 30 μm. That is to say, there is performed an average of five pieces of the sample materials for each of the evaluation therefor as more specifically thereto. And then there is determined for a value of such the resistance thereof as lower than 10 mΩ to be as “∘ (GOOD)”, meanwhile, for a value of such the resistance thereof as not lower than 10 mΩ but lower than 15 mΩ to be as “Δ (ACCEPTABLE)” on the contrary thereto, and meanwhile, for a value of such the resistance thereof as not lower than 15 mΩ to be as “x (NO GOOD)” on the contrary thereto, and then there is shown each of the results in Table 1 through Table 6 respectively. Furthermore, Table 6 shows a comparative example in a case where there is not made use of any of such the ether compounds at all.

(Measurement of Coefficient of Dynamic Friction)

Here, there is performed a measurement of a coefficient of dynamic friction in order to evaluate a property of sliding for each of the test sample bodies. And then there is designed for each of the conditions for the measurement in such the case thereof to be that there is designed for a hard spherical probe that has a radius (R) which is equal to 3.0 mm in a measuring apparatus to be contacted with pressuring by the load of approximately 1 N on to a flat plate of each of the test sample bodies respectively, and to be that the distance of sliding to be as approximately ten millimeters, the velocity of sliding to be as approximately a hundred millimeters per minute, the number of times for sliding to be as one time that is just one way thereof, and to be that there is designed for an ambient atmosphere to be as a temperature of 20° C. and a humidity of 65% Rh approximately. Furthermore, regarding such the property of sliding, there is determined for a sample material to satisfy a predetermined level that is required therefor to be as “∘ (GOOD)”, and meanwhile, there is determined therefor not to satisfy such the predetermined level to be as “x (NO GOOD)” on the contrary thereto.

(Evaluation of Appearance)

Here, there is performed an evaluation of an appearance for each of the test sample bodies that are prepared therefor in the period of the slight sliding by the number of times as 10000, that is similar to the process of the observation and the confirmation of the increase in the resistance thereof. That is to say, there is performed an average of five pieces of the sample materials for each of the evaluation therefor as more specifically thereto. And then in the period of such the slight sliding with the number of times as between 8000 and 10000, there is defined to be as “∘ (GOOD)” for a case where there is almost no dispersion of the ether compound therein to an outer side of such the test sample body. While, there is defined to be as “Δ (ACCEPTABLE)” for a case where there is almost no dispersion of the ether compound therein to an outer side of such the test sample body in the period thereof with the number of times as not less than 3000 but less than 8000, but for a case where there are observed a lot of dispersion of the ether compound therein to the outer side of such the test sample body in the period thereof with the number of times as not less than 8000 on the contrary thereto. And while, there is defined to be as “x (NO GOOD)” for a case where there are observed a lot of dispersion of the ether compound therein to the outer side of such the test sample body in the period thereof with the number of times as less than 3000 on the contrary thereto. Moreover, there is shown each of the results of such the evaluations thereof in Table 7 and in Table 8 respectively.

Further, regarding an observation and then a confirmation of an ether linkage group therein, there is performed a measurement of a infrared absorption spectrum (an IR) by making use of the Fourier transform infrared spectrophotometer named as FREEXACT™ FT-730 that is produced by HORIBA, Ltd., and then thereby performing such the observation and then the confirmation thereof.

Furthermore, regarding a thickness of the organic coating therein, there is performed a measurement of the organic coating therein for each of the test sample bodies by making use of the CHEMICAL IMPEDANCE METER that is produced by HIOKI E.E. CORPORATION.

TABLE 1

| TEST | | | |
|---|---|---|---|
| SAMPLE | | TEST SAMPLE MATERIAL | |
| BODY No. | NATURE OF ETHER COMPOUND | SIDE OF THE PLATE | SIDE OF THE INDENT |
| 101 | PENTAPHENYL ETHER | TEST SAMPLE MATERIAL 1 | TEST SAMPLE MATERIAL 1 |
| 102 | PENTAPHENYL ETHER | TEST SAMPLE MATERIAL 2 | TEST SAMPLE MATERIAL 1 |
| 103 | PENTAPHENYL ETHER | TEST SAMPLE MATERIAL 3 | TEST SAMPLE MATERIAL 1 |
| 104 | PENTAPHENYL ETHER | TEST SAMPLE MATERIAL 4 | TEST SAMPLE MATERIAL 1 |
| 105 | NONYLDIPHENYL ETHER | TEST SAMPLE MATERIAL 1 | TEST SAMPLE MATERIAL 1 |
| 106 | NONYLDIPHENYL ETHER | TEST SAMPLE MATERIAL 2 | TEST SAMPLE MATERIAL 1 |
| 107 | NONYLDIPHENYL ETHER | TEST SAMPLE MATERIAL 3 | TEST SAMPLE MATERIAL 1 |
| 108 | NONYLDIPHENYL ETHER | TEST SAMPLE MATERIAL 4 | TEST SAMPLE MATERIAL 1 |
| 109 | DIPROPYL ETHER | TEST SAMPLE MATERIAL 1 | TEST SAMPLE MATERIAL 1 |
| 110 | DIPROPYL ETHER | TEST SAMPLE MATERIAL 2 | TEST SAMPLE MATERIAL 1 |
| 111 | DIPROPYL ETHER | TEST SAMPLE MATERIAL 3 | TEST SAMPLE MATERIAL 1 |
| 112 | DIPROPYL ETHER | TEST SAMPLE MATERIAL 4 | TEST SAMPLE MATERIAL 1 |
| 113 | ALLYL PHENYL ETHER | TEST SAMPLE MATERIAL 1 | TEST SAMPLE MATERIAL 1 |
| 114 | ALLYL PHENYL ETHER | TEST SAMPLE MATERIAL 2 | TEST SAMPLE MATERIAL 1 |
| 115 | ALLYL PHENYL ETHER | TEST SAMPLE MATERIAL 3 | TEST SAMPLE MATERIAL 1 |
| 116 | ALLYL PHENYL ETHER | TEST SAMPLE MATERIAL 4 | TEST SAMPLE MATERIAL 1 |
| 117 | ETHYL ISOBUTYL ETHER | TEST SAMPLE MATERIAL 1 | TEST SAMPLE MATERIAL 1 |
| 118 | ETHYL ISOBUTYL ETHER | TEST SAMPLE MATERIAL 2 | TEST SAMPLE MATERIAL 1 |
| 119 | ETHYL ISOBUTYL ETHER | TEST SAMPLE MATERIAL 3 | TEST SAMPLE MATERIAL 1 |
| 120 | ETHYL ISOBUTYL ETHER | TEST SAMPLE MATERIAL 4 | TEST SAMPLE MATERIAL 1 |
| 121 | ETHYLENE GLYCOL DIPHENYL ETHER | TEST SAMPLE MATERIAL 1 | TEST SAMPLE MATERIAL 1 |
| 122 | ETHYLENE GLYCOL DIPHENYL ETHER | TEST SAMPLE MATERIAL 2 | TEST SAMPLE MATERIAL 1 |
| 123 | ETHYLENE GLYCOL DIPHENYL ETHER | TEST SAMPLE MATERIAL 3 | TEST SAMPLE MATERIAL 1 |
| 124 | ETHYLENE GLYCOL DIPHENYL ETHER | TEST SAMPLE MATERIAL 4 | TEST SAMPLE MATERIAL 1 |
| 125 | TETRAPHENYL ETHER | TEST SAMPLE MATERIAL 1 | TEST SAMPLE MATERIAL 1 |
| 126 | TETRAPHENYL ETHER | TEST SAMPLE MATERIAL 2 | TEST SAMPLE MATERIAL 1 |
| 127 | TETRAPHENYL ETHER | TEST SAMPLE MATERIAL 3 | TEST SAMPLE MATERIAL 1 |
| 128 | TETRAPHENYL ETHER | TEST SAMPLE MATERIAL 4 | TEST SAMPLE MATERIAL 1 |
| 129 | TRIPHENYL ETHER | TEST SAMPLE MATERIAL 1 | TEST SAMPLE MATERIAL 1 |
| 130 | TRIPHENYL ETHER | TEST SAMPLE MATERIAL 2 | TEST SAMPLE MATERIAL 1 |
| 131 | TRIPHENYL ETHER | TEST SAMPLE MATERIAL 3 | TEST SAMPLE MATERIAL 1 |
| 132 | TRIPHENYL ETHER | TEST SAMPLE MATERIAL 4 | TEST SAMPLE MATERIAL 1 |

| | | | INCREASE OF RESISTANCE | | |
|---|---|---|---|---|---|
| | | | THE NUMBER | THE NUMBER | THE NUMBER |
| TEST | PROPERTY | | OF TIMES | OF TIMES | OF TIMES |
| SAMPLE | OF | INITIAL | FROM ZERO | FROM 1000 TO | FROM 3000 TO |
| BODY No. | SLIDING | RESISTANCE | TO 1000 | 3000 | 10000 |
| 101 | ◯ | ◯ | ◯ | Δ | X |
| 102 | ◯ | ◯ | ◯ | Δ | X |
| 103 | ◯ | ◯ | ◯ | Δ | X |
| 104 | ◯ | ◯ | ◯ | Δ | X |
| 105 | ◯ | ◯ | ◯ | ◯ | ◯ |
| 106 | ◯ | ◯ | ◯ | ◯ | ◯ |
| 107 | ◯ | ◯ | ◯ | ◯ | ◯ |
| 108 | ◯ | ◯ | ◯ | ◯ | ◯ |
| 109 | ◯ | ◯ | ◯ | ◯ | ◯ |
| 110 | ◯ | ◯ | ◯ | ◯ | ◯ |
| 111 | ◯ | ◯ | ◯ | ◯ | ◯ |
| 112 | ◯ | ◯ | ◯ | ◯ | ◯ |
| 113 | ◯ | ◯ | ◯ | ◯ | ◯ |
| 114 | ◯ | ◯ | ◯ | ◯ | ◯ |
| 115 | ◯ | ◯ | ◯ | ◯ | ◯ |
| 116 | ◯ | ◯ | ◯ | ◯ | ◯ |
| 117 | ◯ | ◯ | ◯ | ◯ | ◯ |
| 118 | ◯ | ◯ | ◯ | ◯ | ◯ |
| 119 | ◯ | ◯ | ◯ | ◯ | ◯ |
| 120 | ◯ | ◯ | ◯ | ◯ | ◯ |
| 121 | ◯ | ◯ | ◯ | ◯ | ◯ |
| 122 | ◯ | ◯ | ◯ | ◯ | ◯ |
| 123 | ◯ | ◯ | ◯ | ◯ | ◯ |
| 124 | ◯ | ◯ | ◯ | ◯ | ◯ |
| 125 | ◯ | ◯ | ◯ | ◯ | ◯ |
| 126 | ◯ | ◯ | ◯ | ◯ | ◯ |
| 127 | ◯ | ◯ | ◯ | ◯ | ◯ |
| 128 | ◯ | ◯ | ◯ | ◯ | ◯ |
| 129 | ◯ | ◯ | ◯ | ◯ | ◯ |
| 130 | ◯ | ◯ | ◯ | ◯ | ◯ |
| 131 | ◯ | ◯ | ◯ | ◯ | ◯ |
| 132 | ◯ | ◯ | ◯ | ◯ | ◯ |

TABLE 2

| TEST | | | |
|---|---|---|---|
| SAMPLE | | TEST SAMPLE MATERIAL | |
| BODY No. | NATURE OF ETHER COMPOUND | SIDE OF THE PLATE | SIDE OF THE INDENT |
| 201 | PENTAPHENYL ETHER | TEST SAMPLE MATERIAL 1 | TEST SAMPLE MATERIAL 2 |
| 202 | PENTAPHENYL ETHER | TEST SAMPLE MATERIAL 2 | TEST SAMPLE MATERIAL 2 |
| 203 | PENTAPHENYL ETHER | TEST SAMPLE MATERIAL 3 | TEST SAMPLE MATERIAL 2 |
| 204 | PENTAPHENYL ETHER | TEST SAMPLE MATERIAL 4 | TEST SAMPLE MATERIAL 2 |
| 205 | NONYLDIPHENYL ETHER | TEST SAMPLE MATERIAL 1 | TEST SAMPLE MATERIAL 2 |
| 206 | NONYLDIPHENYL ETHER | TEST SAMPLE MATERIAL 2 | TEST SAMPLE MATERIAL 2 |
| 207 | NONYLDIPHENYL ETHER | TEST SAMPLE MATERIAL 3 | TEST SAMPLE MATERIAL 2 |
| 208 | NONYLDIPHENYL ETHER | TEST SAMPLE MATERIAL 4 | TEST SAMPLE MATERIAL 2 |
| 209 | DIPROPYL ETHER | TEST SAMPLE MATERIAL 1 | TEST SAMPLE MATERIAL 2 |
| 210 | DIPROPYL ETHER | TEST SAMPLE MATERIAL 2 | TEST SAMPLE MATERIAL 2 |
| 211 | DIPROPYL ETHER | TEST SAMPLE MATERIAL 3 | TEST SAMPLE MATERIAL 2 |
| 212 | DIPROPYL ETHER | TEST SAMPLE MATERIAL 4 | TEST SAMPLE MATERIAL 2 |
| 213 | ALLYL PHENYL ETHER | TEST SAMPLE MATERIAL 1 | TEST SAMPLE MATERIAL 2 |
| 214 | ALLYL PHENYL ETHER | TEST SAMPLE MATERIAL 2 | TEST SAMPLE MATERIAL 2 |
| 215 | ALLYL PHENYL ETHER | TEST SAMPLE MATERIAL 3 | TEST SAMPLE MATERIAL 2 |
| 216 | ALLYL PHENYL ETHER | TEST SAMPLE MATERIAL 4 | TEST SAMPLE MATERIAL 2 |
| 217 | ETHYL ISOBUTYL ETHER | TEST SAMPLE MATERIAL 1 | TEST SAMPLE MATERIAL 2 |
| 218 | ETHYL ISOBUTYL ETHER | TEST SAMPLE MATERIAL 2 | TEST SAMPLE MATERIAL 2 |
| 219 | ETHYL ISOBUTYL ETHER | TEST SAMPLE MATERIAL 3 | TEST SAMPLE MATERIAL 2 |
| 220 | ETHYL ISOBUTYL ETHER | TEST SAMPLE MATERIAL 4 | TEST SAMPLE MATERIAL 2 |
| 221 | ETHYLENE GLYCOL DIPHENYL ETHER | TEST SAMPLE MATERIAL 1 | TEST SAMPLE MATERIAL 2 |
| 222 | ETHYLENE GLYCOL DIPHENYL ETHER | TEST SAMPLE MATERIAL 2 | TEST SAMPLE MATERIAL 2 |
| 223 | ETHYLENE GLYCOL DIPHENYL ETHER | TEST SAMPLE MATERIAL 3 | TEST SAMPLE MATERIAL 2 |
| 224 | ETHYLENE GLYCOL DIPHENYL ETHER | TEST SAMPLE MATERIAL 4 | TEST SAMPLE MATERIAL 2 |
| 225 | TETRAPHENYL ETHER | TEST SAMPLE MATERIAL 1 | TEST SAMPLE MATERIAL 2 |
| 226 | TETRAPHENYL ETHER | TEST SAMPLE MATERIAL 2 | TEST SAMPLE MATERIAL 2 |
| 227 | TETRAPHENYL ETHER | TEST SAMPLE MATERIAL 3 | TEST SAMPLE MATERIAL 2 |
| 228 | TETRAPHENYL ETHER | TEST SAMPLE MATERIAL 4 | TEST SAMPLE MATERIAL 2 |
| 229 | TRIPHENYL ETHER | TEST SAMPLE MATERIAL 1 | TEST SAMPLE MATERIAL 2 |
| 230 | TRIPHENYL ETHER | TEST SAMPLE MATERIAL 2 | TEST SAMPLE MATERIAL 2 |
| 231 | TRIPHENYL ETHER | TEST SAMPLE MATERIAL 3 | TEST SAMPLE MATERIAL 2 |
| 232 | TRIPHENYL ETHER | TEST SAMPLE MATERIAL 4 | TEST SAMPLE MATERIAL 2 |

| | | | INCREASE OF RESISTANCE | | |
|---|---|---|---|---|---|
| | | | THE NUMBER | THE NUMBER | THE NUMBER |
| TEST | PROPERTY | | OF TIMES | OF TIMES | OF TIMES |
| SAMPLE | OF | INITIAL | FROM ZERO | FROM 1000 | FROM 3000 |
| BODY No. | SLIDING | RESISTANCE | TO 1000 | TO 3000 | TO 10000 |
| 201 | ◯ | ◯ | ◯ | Δ | X |
| 202 | ◯ | ◯ | ◯ | Δ | X |
| 203 | ◯ | ◯ | ◯ | Δ | X |
| 204 | ◯ | ◯ | ◯ | Δ | X |
| 205 | ◯ | ◯ | ◯ | ◯ | ◯ |
| 206 | ◯ | ◯ | ◯ | ◯ | ◯ |
| 207 | ◯ | ◯ | ◯ | ◯ | ◯ |
| 208 | ◯ | ◯ | ◯ | ◯ | ◯ |
| 209 | ◯ | ◯ | ◯ | ◯ | ◯ |
| 210 | ◯ | ◯ | ◯ | ◯ | ◯ |
| 211 | ◯ | ◯ | ◯ | ◯ | ◯ |
| 212 | ◯ | ◯ | ◯ | ◯ | ◯ |
| 213 | ◯ | ◯ | ◯ | ◯ | ◯ |
| 214 | ◯ | ◯ | ◯ | ◯ | ◯ |
| 215 | ◯ | ◯ | ◯ | ◯ | ◯ |
| 216 | ◯ | ◯ | ◯ | ◯ | ◯ |
| 217 | ◯ | ◯ | ◯ | ◯ | ◯ |
| 218 | ◯ | ◯ | ◯ | ◯ | ◯ |
| 219 | ◯ | ◯ | ◯ | ◯ | ◯ |
| 220 | ◯ | ◯ | ◯ | ◯ | ◯ |
| 221 | ◯ | ◯ | ◯ | ◯ | ◯ |
| 222 | ◯ | ◯ | ◯ | ◯ | ◯ |
| 223 | ◯ | ◯ | ◯ | ◯ | ◯ |
| 224 | ◯ | ◯ | ◯ | ◯ | ◯ |
| 225 | ◯ | ◯ | ◯ | ◯ | ◯ |
| 226 | ◯ | ◯ | ◯ | ◯ | ◯ |
| 227 | ◯ | ◯ | ◯ | ◯ | ◯ |
| 228 | ◯ | ◯ | ◯ | ◯ | ◯ |
| 229 | ◯ | ◯ | ◯ | ◯ | ◯ |
| 230 | ◯ | ◯ | ◯ | ◯ | ◯ |
| 231 | ◯ | ◯ | ◯ | ◯ | ◯ |
| 232 | ◯ | ◯ | ◯ | ◯ | ◯ |

TABLE 3

| TEST | | | |
|---|---|---|---|
| SAMPLE | | | |
| BODY | | TEST SAMPLE MATERIAL | |
| No. | NATURE OF ETHER COMPOUND | SIDE OF THE PLATE | SIDE OF THE INDENT |
| 301 | PENTAPHENYL ETHER | TEST SAMPLE MATERIAL 1 | TEST SAMPLE MATERIAL 3 |
| 302 | PENTAPHENYL ETHER | TEST SAMPLE MATERIAL 2 | TEST SAMPLE MATERIAL 3 |
| 303 | PENTAPHENYL ETHER | TEST SAMPLE MATERIAL 3 | TEST SAMPLE MATERIAL 3 |
| 304 | PENTAPHENYL ETHER | TEST SAMPLE MATERIAL 4 | TEST SAMPLE MATERIAL 3 |
| 305 | NONYLDIPHENYL ETHER | TEST SAMPLE MATERIAL 1 | TEST SAMPLE MATERIAL 3 |
| 306 | NONYLDIPHENYL ETHER | TEST SAMPLE MATERIAL 2 | TEST SAMPLE MATERIAL 3 |
| 307 | NONYLDIPHENYL ETHER | TEST SAMPLE MATERIAL 3 | TEST SAMPLE MATERIAL 3 |
| 308 | NONYLDIPHENYL ETHER | TEST SAMPLE MATERIAL 4 | TEST SAMPLE MATERIAL 3 |
| 309 | DIPROPYL ETHER | TEST SAMPLE MATERIAL 1 | TEST SAMPLE MATERIAL 3 |
| 310 | DIPROPYL ETHER | TEST SAMPLE MATERIAL 2 | TEST SAMPLE MATERIAL 3 |
| 311 | DIPROPYL ETHER | TEST SAMPLE MATERIAL 3 | TEST SAMPLE MATERIAL 3 |
| 312 | DIPROPYL ETHER | TEST SAMPLE MATERIAL 4 | TEST SAMPLE MATERIAL 3 |
| 313 | ALLYL PHENYL ETHER | TEST SAMPLE MATERIAL 1 | TEST SAMPLE MATERIAL 3 |
| 314 | ALLYL PHENYL ETHER | TEST SAMPLE MATERIAL 2 | TEST SAMPLE MATERIAL 3 |
| 315 | ALLYL PHENYL ETHER | TEST SAMPLE MATERIAL 3 | TEST SAMPLE MATERIAL 3 |
| 316 | ALLYL PHENYL ETHER | TEST SAMPLE MATERIAL 4 | TEST SAMPLE MATERIAL 3 |
| 317 | ETHYL ISOBUTYL ETHER | TEST SAMPLE MATERIAL 1 | TEST SAMPLE MATERIAL 3 |
| 318 | ETHYL ISOBUTYL ETHER | TEST SAMPLE MATERIAL 2 | TEST SAMPLE MATERIAL 3 |
| 319 | ETHYL ISOBUTYL ETHER | TEST SAMPLE MATERIAL 3 | TEST SAMPLE MATERIAL 3 |
| 320 | ETHYL ISOBUTYL ETHER | TEST SAMPLE MATERIAL 4 | TEST SAMPLE MATERIAL 3 |
| 321 | ETHYLENE GLYCOL DIPHENYL ETHER | TEST SAMPLE MATERIAL 1 | TEST SAMPLE MATERIAL 3 |
| 322 | ETHYLENE GLYCOL DIPHENYL ETHER | TEST SAMPLE MATERIAL 2 | TEST SAMPLE MATERIAL 3 |
| 323 | ETHYLENE GLYCOL DIPHENYL ETHER | TEST SAMPLE MATERIAL 3 | TEST SAMPLE MATERIAL 3 |
| 324 | ETHYLENE GLYCOL DIPHENYL ETHER | TEST SAMPLE MATERIAL 4 | TEST SAMPLE MATERIAL 3 |
| 325 | TETRAPHENYL ETHER | TEST SAMPLE MATERIAL 1 | TEST SAMPLE MATERIAL 3 |
| 326 | TETRAPHENYL ETHER | TEST SAMPLE MATERIAL 2 | TEST SAMPLE MATERIAL 3 |
| 327 | TETRAPHENYL ETHER | TEST SAMPLE MATERIAL 3 | TEST SAMPLE MATERIAL 3 |
| 328 | TETRAPHENYL ETHER | TEST SAMPLE MATERIAL 4 | TEST SAMPLE MATERIAL 3 |
| 329 | TRIPHENYL ETHER | TEST SAMPLE MATERIAL 1 | TEST SAMPLE MATERIAL 3 |
| 330 | TRIPHENYL ETHER | TEST SAMPLE MATERIAL 2 | TEST SAMPLE MATERIAL 3 |
| 331 | TRIPHENYL ETHER | TEST SAMPLE MATERIAL 3 | TEST SAMPLE MATERIAL 3 |
| 332 | TRIPHENYL ETHER | TEST SAMPLE MATERIAL 4 | TEST SAMPLE MATERIAL 3 |

| | | | INCREASE OF RESISTANCE | | |
|---|---|---|---|---|---|
| TEST | | | THE NUMBER | THE NUMBER | THE NUMBER |
| SAMPLE | PROPERTY | | OF TIMES | OF TIMES | OF TIMES |
| BODY | OF | INITIAL | FROM ZERO | FROM 1000 | FROM 3000 |
| No. | SLIDING | RESISTANCE | TO 1000 | TO 3000 | TO 10000 |
| 301 | ◯ | ◯ | ◯ | Δ | X |
| 302 | ◯ | ◯ | ◯ | Δ | X |
| 303 | ◯ | ◯ | ◯ | Δ | X |
| 304 | ◯ | ◯ | ◯ | Δ | X |
| 305 | ◯ | ◯ | ◯ | ◯ | ◯ |
| 306 | ◯ | ◯ | ◯ | ◯ | ◯ |
| 307 | ◯ | ◯ | ◯ | ◯ | ◯ |
| 308 | ◯ | ◯ | ◯ | ◯ | ◯ |
| 309 | ◯ | ◯ | ◯ | ◯ | ◯ |
| 310 | ◯ | ◯ | ◯ | ◯ | ◯ |
| 311 | ◯ | ◯ | ◯ | ◯ | ◯ |
| 312 | ◯ | ◯ | ◯ | ◯ | ◯ |
| 313 | ◯ | ◯ | ◯ | ◯ | ◯ |
| 314 | ◯ | ◯ | ◯ | ◯ | ◯ |
| 315 | ◯ | ◯ | ◯ | ◯ | ◯ |
| 316 | ◯ | ◯ | ◯ | ◯ | ◯ |
| 317 | ◯ | ◯ | ◯ | ◯ | ◯ |
| 318 | ◯ | ◯ | ◯ | ◯ | ◯ |
| 319 | ◯ | ◯ | ◯ | ◯ | ◯ |
| 320 | ◯ | ◯ | ◯ | ◯ | ◯ |
| 321 | ◯ | ◯ | ◯ | ◯ | ◯ |
| 322 | ◯ | ◯ | ◯ | ◯ | ◯ |
| 323 | ◯ | ◯ | ◯ | ◯ | ◯ |
| 324 | ◯ | ◯ | ◯ | ◯ | ◯ |
| 325 | ◯ | ◯ | ◯ | ◯ | ◯ |
| 326 | ◯ | ◯ | ◯ | ◯ | ◯ |
| 327 | ◯ | ◯ | ◯ | ◯ | ◯ |
| 328 | ◯ | ◯ | ◯ | ◯ | ◯ |
| 329 | ◯ | ◯ | ◯ | ◯ | ◯ |
| 330 | ◯ | ◯ | ◯ | ◯ | ◯ |
| 331 | ◯ | ◯ | ◯ | ◯ | ◯ |
| 332 | ◯ | ◯ | ◯ | ◯ | ◯ |

TABLE 4

| TEST | | | |
|---|---|---|---|
| SAMPLE | | TEST SAMPLE MATERIAL | |
| BODY No. | NATURE OF ETHER COMPOUND | SIDE OF THE PLATE | SIDE OF THE INDENT |
| 401 | PENTAPHENYL ETHER | TEST SAMPLE MATERIAL 1 | TEST SAMPLE MATERIAL 4 |
| 402 | PENTAPHENYL ETHER | TEST SAMPLE MATERIAL 2 | TEST SAMPLE MATERIAL 4 |
| 403 | PENTAPHENYL ETHER | TEST SAMPLE MATERIAL 3 | TEST SAMPLE MATERIAL 4 |
| 404 | PENTAPHENYL ETHER | TEST SAMPLE MATERIAL 4 | TEST SAMPLE MATERIAL 4 |
| 405 | NONYLDIPHENYL ETHER | TEST SAMPLE MATERIAL 1 | TEST SAMPLE MATERIAL 4 |
| 406 | NONYLDIPHENYL ETHER | TEST SAMPLE MATERIAL 2 | TEST SAMPLE MATERIAL 4 |
| 407 | NONYLDIPHENYL ETHER | TEST SAMPLE MATERIAL 3 | TEST SAMPLE MATERIAL 4 |
| 408 | NONYLDIPHENYL ETHER | TEST SAMPLE MATERIAL 4 | TEST SAMPLE MATERIAL 4 |
| 409 | DIPROPYL ETHER | TEST SAMPLE MATERIAL 1 | TEST SAMPLE MATERIAL 4 |
| 410 | DIPROPYL ETHER | TEST SAMPLE MATERIAL 2 | TEST SAMPLE MATERIAL 4 |
| 411 | DIPROPYL ETHER | TEST SAMPLE MATERIAL 3 | TEST SAMPLE MATERIAL 4 |
| 412 | DIPROPYL ETHER | TEST SAMPLE MATERIAL 4 | TEST SAMPLE MATERIAL 4 |
| 413 | ALLYL PHENYL ETHER | TEST SAMPLE MATERIAL 1 | TEST SAMPLE MATERIAL 4 |
| 414 | ALLYL PHENYL ETHER | TEST SAMPLE MATERIAL 2 | TEST SAMPLE MATERIAL 4 |
| 415 | ALLYL PHENYL ETHER | TEST SAMPLE MATERIAL 3 | TEST SAMPLE MATERIAL 4 |
| 416 | ALLYL PHENYL ETHER | TEST SAMPLE MATERIAL 4 | TEST SAMPLE MATERIAL 4 |
| 417 | ETHYL ISOBUTYL ETHER | TEST SAMPLE MATERIAL 1 | TEST SAMPLE MATERIAL 4 |
| 418 | ETHYL ISOBUTYL ETHER | TEST SAMPLE MATERIAL 2 | TEST SAMPLE MATERIAL 4 |
| 419 | ETHYL ISOBUTYL ETHER | TEST SAMPLE MATERIAL 3 | TEST SAMPLE MATERIAL 4 |
| 420 | ETHYL ISOBUTYL ETHER | TEST SAMPLE MATERIAL 4 | TEST SAMPLE MATERIAL 4 |
| 421 | ETHYLENE GLYCOL DIPHENYL ETHER | TEST SAMPLE MATERIAL 1 | TEST SAMPLE MATERIAL 4 |
| 422 | ETHYLENE GLYCOL DIPHENYL ETHER | TEST SAMPLE MATERIAL 2 | TEST SAMPLE MATERIAL 4 |
| 423 | ETHYLENE GLYCOL DIPHENYL ETHER | TEST SAMPLE MATERIAL 3 | TEST SAMPLE MATERIAL 4 |
| 424 | ETHYLENE GLYCOL DIPHENYL ETHER | TEST SAMPLE MATERIAL 4 | TEST SAMPLE MATERIAL 4 |
| 425 | TETRAPHENYL ETHER | TEST SAMPLE MATERIAL 1 | TEST SAMPLE MATERIAL 4 |
| 426 | TETRAPHENYL ETHER | TEST SAMPLE MATERIAL 2 | TEST SAMPLE MATERIAL 4 |
| 427 | TETRAPHENYL ETHER | TEST SAMPLE MATERIAL 3 | TEST SAMPLE MATERIAL 4 |
| 428 | TETRAPHENYL ETHER | TEST SAMPLE MATERIAL 4 | TEST SAMPLE MATERIAL 4 |
| 429 | TRIPHENYL ETHER | TEST SAMPLE MATERIAL 1 | TEST SAMPLE MATERIAL 4 |
| 430 | TRIPHENYL ETHER | TEST SAMPLE MATERIAL 2 | TEST SAMPLE MATERIAL 4 |
| 431 | TRIPHENYL ETHER | TEST SAMPLE MATERIAL 3 | TEST SAMPLE MATERIAL 4 |
| 432 | TRIPHENYL ETHER | TEST SAMPLE MATERIAL 4 | TEST SAMPLE MATERIAL 4 |

| | | | INCREASE OF RESISTANCE | | |
|---|---|---|---|---|---|
| | | | THE NUMBER | THE NUMBER | THE NUMBER |
| TEST | PROPERTY | | OF TIMES | OF TIMES | OF TIMES |
| SAMPLE | OF | INITIAL | FROM ZERO | FROM 1000 | FROM 3000 |
| BODY No. | SLIDING | RESISTANCE | TO 1000 | TO 3000 | TO 10000 |
| 401 | ◯ | ◯ | ◯ | Δ | X |
| 402 | ◯ | ◯ | ◯ | Δ | X |
| 403 | ◯ | ◯ | ◯ | Δ | X |
| 404 | ◯ | ◯ | ◯ | Δ | X |
| 405 | ◯ | ◯ | ◯ | ◯ | ◯ |
| 406 | ◯ | ◯ | ◯ | ◯ | ◯ |
| 407 | ◯ | ◯ | ◯ | ◯ | ◯ |
| 408 | ◯ | ◯ | ◯ | ◯ | ◯ |
| 409 | ◯ | ◯ | ◯ | ◯ | ◯ |
| 410 | ◯ | ◯ | ◯ | ◯ | ◯ |
| 411 | ◯ | ◯ | ◯ | ◯ | ◯ |
| 412 | ◯ | ◯ | ◯ | ◯ | ◯ |
| 413 | ◯ | ◯ | ◯ | ◯ | ◯ |
| 414 | ◯ | ◯ | ◯ | ◯ | ◯ |
| 415 | ◯ | ◯ | ◯ | ◯ | ◯ |
| 416 | ◯ | ◯ | ◯ | ◯ | ◯ |
| 417 | ◯ | ◯ | ◯ | ◯ | ◯ |
| 418 | ◯ | ◯ | ◯ | ◯ | ◯ |
| 419 | ◯ | ◯ | ◯ | ◯ | ◯ |
| 420 | ◯ | ◯ | ◯ | ◯ | ◯ |
| 421 | ◯ | ◯ | ◯ | ◯ | ◯ |
| 422 | ◯ | ◯ | ◯ | ◯ | ◯ |
| 423 | ◯ | ◯ | ◯ | ◯ | ◯ |
| 424 | ◯ | ◯ | ◯ | ◯ | ◯ |
| 425 | ◯ | ◯ | ◯ | ◯ | ◯ |
| 426 | ◯ | ◯ | ◯ | ◯ | ◯ |
| 427 | ◯ | ◯ | ◯ | ◯ | ◯ |
| 428 | ◯ | ◯ | ◯ | ◯ | ◯ |
| 429 | ◯ | ◯ | ◯ | ◯ | ◯ |
| 430 | ◯ | ◯ | ◯ | ◯ | ◯ |
| 431 | ◯ | ◯ | ◯ | ◯ | ◯ |
| 432 | ◯ | ◯ | ◯ | ◯ | ◯ |

TABLE 5

| TEST | | | |
|---|---|---|---|
| SAMPLE | | | |
| BODY | | TEST SAMPLE MATERIAL | |
| No. | NATURE OF ETHER COMPOUND | SIDE OF THE PLATE | SIDE OF THE INDENT |
| 501 | PENTAPHENYL ETHER | TEST SAMPLE MATERIAL 5 | TEST SAMPLE MATERIAL 1 |
| 502 | PENTAPHENYL ETHER | TEST SAMPLE MATERIAL 1 | TEST SAMPLE MATERIAL 5 |
| 503 | PENTAPHENYL ETHER | TEST SAMPLE MATERIAL 5 | TEST SAMPLE MATERIAL 5 |
| 504 | PENTAPHENYL ETHER | TEST SAMPLE MATERIAL 6 | TEST SAMPLE MATERIAL 1 |
| 505 | PENTAPHENYL ETHER | TEST SAMPLE MATERIAL 1 | TEST SAMPLE MATERIAL 6 |
| 506 | PENTAPHENYL ETHER | TEST SAMPLE MATERIAL 6 | TEST SAMPLE MATERIAL 6 |
| 507 | PENTAPHENYL ETHER | TEST SAMPLE MATERIAL 7 | TEST SAMPLE MATERIAL 7 |
| 508 | NONYLDIPHENYL ETHER | TEST SAMPLE MATERIAL 5 | TEST SAMPLE MATERIAL 1 |
| 509 | NONYLDIPHENYL ETHER | TEST SAMPLE MATERIAL 1 | TEST SAMPLE MATERIAL 5 |
| 510 | NONYLDIPHENYL ETHER | TEST SAMPLE MATERIAL 5 | TEST SAMPLE MATERIAL 5 |
| 511 | NONYLDIPHENYL ETHER | TEST SAMPLE MATERIAL 6 | TEST SAMPLE MATERIAL 1 |
| 512 | NONYLDIPHENYL ETHER | TEST SAMPLE MATERIAL 1 | TEST SAMPLE MATERIAL 6 |
| 513 | NONYLDIPHENYL ETHER | TEST SAMPLE MATERIAL 6 | TEST SAMPLE MATERIAL 6 |
| 514 | NONYLDIPHENYL ETHER | TEST SAMPLE MATERIAL 7 | TEST SAMPLE MATERIAL 7 |
| 515 | DIPROPYL ETHER | TEST SAMPLE MATERIAL 5 | TEST SAMPLE MATERIAL 1 |
| 516 | DIPROPYL ETHER | TEST SAMPLE MATERIAL 1 | TEST SAMPLE MATERIAL 5 |
| 517 | DIPROPYL ETHER | TEST SAMPLE MATERIAL 5 | TEST SAMPLE MATERIAL 5 |
| 518 | DIPROPYL ETHER | TEST SAMPLE MATERIAL 6 | TEST SAMPLE MATERIAL 1 |
| 519 | DIPROPYL ETHER | TEST SAMPLE MATERIAL 1 | TEST SAMPLE MATERIAL 6 |
| 520 | DIPROPYL ETHER | TEST SAMPLE MATERIAL 6 | TEST SAMPLE MATERIAL 6 |
| 521 | DIPROPYL ETHER | TEST SAMPLE MATERIAL 7 | TEST SAMPLE MATERIAL 7 |
| 522 | ALLYL PHENYL ETHER | TEST SAMPLE MATERIAL 5 | TEST SAMPLE MATERIAL 1 |
| 523 | ALLYL PHENYL ETHER | TEST SAMPLE MATERIAL 1 | TEST SAMPLE MATERIAL 5 |
| 524 | ALLYL PHENYL ETHER | TEST SAMPLE MATERIAL 5 | TEST SAMPLE MATERIAL 5 |
| 525 | ALLYL PHENYL ETHER | TEST SAMPLE MATERIAL 6 | TEST SAMPLE MATERIAL 1 |
| 526 | ALLYL PHENYL ETHER | TEST SAMPLE MATERIAL 1 | TEST SAMPLE MATERIAL 6 |
| 527 | ALLYL PHENYL ETHER | TEST SAMPLE MATERIAL 6 | TEST SAMPLE MATERIAL 6 |
| 528 | ALLYL PHENYL ETHER | TEST SAMPLE MATERIAL 7 | TEST SAMPLE MATERIAL 7 |
| 529 | ETHYL ISOBUTYL ETHER | TEST SAMPLE MATERIAL 5 | TEST SAMPLE MATERIAL 1 |
| 530 | ETHYL ISOBUTYL ETHER | TEST SAMPLE MATERIAL 1 | TEST SAMPLE MATERIAL 5 |
| 531 | ETHYL ISOBUTYL ETHER | TEST SAMPLE MATERIAL 5 | TEST SAMPLE MATERIAL 5 |
| 532 | ETHYL ISOBUTYL ETHER | TEST SAMPLE MATERIAL 6 | TEST SAMPLE MATERIAL 1 |
| 533 | ETHYL ISOBUTYL ETHER | TEST SAMPLE MATERIAL 1 | TEST SAMPLE MATERIAL 6 |
| 534 | ETHYL ISOBUTYL ETHER | TEST SAMPLE MATERIAL 6 | TEST SAMPLE MATERIAL 6 |
| 535 | ETHYL ISOBUTYL ETHER | TEST SAMPLE MATERIAL 7 | TEST SAMPLE MATERIAL 7 |
| 536 | ETHYLENE GLYCOL DIPHENYL ETHER | TEST SAMPLE MATERIAL 5 | TEST SAMPLE MATERIAL 1 |
| 537 | ETHYLENE GLYCOL DIPHENYL ETHER | TEST SAMPLE MATERIAL 1 | TEST SAMPLE MATERIAL 5 |
| 538 | ETHYLENE GLYCOL DIPHENYL ETHER | TEST SAMPLE MATERIAL 5 | TEST SAMPLE MATERIAL 5 |
| 539 | ETHYLENE GLYCOL DIPHENYL ETHER | TEST SAMPLE MATERIAL 6 | TEST SAMPLE MATERIAL 1 |
| 540 | ETHYLENE GLYCOL DIPHENYL ETHER | TEST SAMPLE MATERIAL 1 | TEST SAMPLE MATERIAL 6 |
| 541 | ETHYLENE GLYCOL DIPHENYL ETHER | TEST SAMPLE MATERIAL 6 | TEST SAMPLE MATERIAL 6 |
| 542 | ETHYLENE GLYCOL DIPHENYL ETHER | TEST SAMPLE MATERIAL 7 | TEST SAMPLE MATERIAL 7 |
| 543 | TETRAPHENYL ETHER | TEST SAMPLE MATERIAL 5 | TEST SAMPLE MATERIAL 1 |
| 544 | TETRAPHENYL ETHER | TEST SAMPLE MATERIAL 1 | TEST SAMPLE MATERIAL 5 |
| 545 | TETRAPHENYL ETHER | TEST SAMPLE MATERIAL 5 | TEST SAMPLE MATERIAL 5 |
| 546 | TETRAPHENYL ETHER | TEST SAMPLE MATERIAL 6 | TEST SAMPLE MATERIAL 1 |
| 547 | TETRAPHENYL ETHER | TEST SAMPLE MATERIAL 1 | TEST SAMPLE MATERIAL 6 |
| 548 | TETRAPHENYL ETHER | TEST SAMPLE MATERIAL 6 | TEST SAMPLE MATERIAL 6 |
| 549 | TETRAPHENYL ETHER | TEST SAMPLE MATERIAL 7 | TEST SAMPLE MATERIAL 7 |
| 550 | TRIPHENYL ETHER | TEST SAMPLE MATERIAL 5 | TEST SAMPLE MATERIAL 1 |
| 551 | TRIPHENYL ETHER | TEST SAMPLE MATERIAL 1 | TEST SAMPLE MATERIAL 5 |
| 552 | TRIPHENYL ETHER | TEST SAMPLE MATERIAL 5 | TEST SAMPLE MATERIAL 5 |
| 553 | TRIPHENYL ETHER | TEST SAMPLE MATERIAL 6 | TEST SAMPLE MATERIAL 1 |
| 554 | TRIPHENYL ETHER | TEST SAMPLE MATERIAL 1 | TEST SAMPLE MATERIAL 6 |
| 555 | TRIPHENYL ETHER | TEST SAMPLE MATERIAL 6 | TEST SAMPLE MATERIAL 6 |
| 556 | TRIPHENYL ETHER | TEST SAMPLE MATERIAL 7 | TEST SAMPLE MATERIAL 7 |

| | | | INCREASE OF RESISTANCE | | |
|---|---|---|---|---|---|
| TEST | | | THE NUMBER | THE NUMBER | THE NUMBER |
| SAMPLE | PROPERTY | | OF TIMES | OF TIMES | OF TIMES |
| BODY | OF | INITIAL | FROM ZERO | FROM 1000 | FROM 3000 |
| No. | SLIDING | RESISTANCE | TO 1000 | TO 3000 | TO 10000 |
| 501 | ◯ | ◯ | ◯ | ◯ | ◯ |
| 502 | ◯ | ◯ | ◯ | ◯ | ◯ |
| 503 | ◯ | ◯ | ◯ | ◯ | ◯ |
| 504 | ◯ | ◯ | ◯ | ◯ | ◯ |
| 505 | ◯ | ◯ | ◯ | ◯ | ◯ |
| 506 | ◯ | ◯ | ◯ | ◯ | ◯ |
| 507 | ◯ | ◯ | ◯ | ◯ | ◯ |
| 508 | ◯ | ◯ | ◯ | ◯ | ◯ |
| 509 | ◯ | ◯ | ◯ | ◯ | ◯ |
| 510 | ◯ | ◯ | ◯ | ◯ | ◯ |
| 511 | ◯ | ◯ | ◯ | ◯ | ◯ |
| 512 | ◯ | ◯ | ◯ | ◯ | ◯ |
| 513 | ◯ | ◯ | ◯ | ◯ | ◯ |
| 514 | ◯ | ◯ | ◯ | ◯ | ◯ |
| 515 | ◯ | ◯ | ◯ | ◯ | ◯ |
| 516 | ◯ | ◯ | ◯ | ◯ | ◯ |
| 517 | ◯ | ◯ | ◯ | ◯ | ◯ |
| 518 | ◯ | ◯ | ◯ | ◯ | ◯ |
| 519 | ◯ | ◯ | ◯ | ◯ | ◯ |
| 520 | ◯ | ◯ | ◯ | ◯ | ◯ |
| 521 | ◯ | ◯ | ◯ | ◯ | ◯ |
| 522 | ◯ | ◯ | ◯ | ◯ | ◯ |
| 523 | ◯ | ◯ | ◯ | ◯ | ◯ |
| 524 | ◯ | ◯ | ◯ | ◯ | ◯ |
| 525 | ◯ | ◯ | ◯ | ◯ | ◯ |
| 526 | ◯ | ◯ | ◯ | ◯ | ◯ |
| 527 | ◯ | ◯ | ◯ | ◯ | ◯ |
| 528 | ◯ | ◯ | ◯ | ◯ | ◯ |
| 529 | ◯ | ◯ | ◯ | ◯ | ◯ |
| 530 | ◯ | ◯ | ◯ | ◯ | ◯ |
| 531 | ◯ | ◯ | ◯ | ◯ | ◯ |
| 532 | ◯ | ◯ | ◯ | ◯ | ◯ |
| 533 | ◯ | ◯ | ◯ | ◯ | ◯ |
| 534 | ◯ | ◯ | ◯ | ◯ | ◯ |
| 535 | ◯ | ◯ | ◯ | ◯ | ◯ |
| 536 | ◯ | ◯ | ◯ | ◯ | ◯ |
| 537 | ◯ | ◯ | ◯ | ◯ | ◯ |
| 538 | ◯ | ◯ | ◯ | ◯ | ◯ |
| 539 | ◯ | ◯ | ◯ | ◯ | ◯ |
| 540 | ◯ | ◯ | ◯ | ◯ | ◯ |
| 541 | ◯ | ◯ | ◯ | ◯ | ◯ |
| 542 | ◯ | ◯ | ◯ | ◯ | ◯ |
| 543 | ◯ | ◯ | ◯ | ◯ | ◯ |
| 544 | ◯ | ◯ | ◯ | ◯ | ◯ |
| 545 | ◯ | ◯ | ◯ | ◯ | ◯ |
| 546 | ◯ | ◯ | ◯ | ◯ | ◯ |
| 547 | ◯ | ◯ | ◯ | ◯ | ◯ |
| 548 | ◯ | ◯ | ◯ | ◯ | ◯ |
| 549 | ◯ | ◯ | ◯ | ◯ | ◯ |
| 550 | ◯ | ◯ | ◯ | ◯ | ◯ |
| 551 | ◯ | ◯ | ◯ | ◯ | ◯ |
| 552 | ◯ | ◯ | ◯ | ◯ | ◯ |
| 553 | ◯ | ◯ | ◯ | ◯ | ◯ |
| 554 | ◯ | ◯ | ◯ | ◯ | ◯ |
| 555 | ◯ | ◯ | ◯ | ◯ | ◯ |
| 556 | ◯ | ◯ | ◯ | ◯ | ◯ |

TABLE 6

| TEST | APPLICATION OF SUCH AS | | |
|---|---|---|---|
| SAMPLE | A LUBRICATING OIL OR | TEST SAMPLE MATERIAL | |
| BODY No. | THE LIKE | SIDE OF THE PLATE | SIDE OF THE INDENT |
| 601 | NOT APPLIED ANY OIL | TEST SAMPLE MATERIAL 2 | TEST SAMPLE MATERIAL 2 |
| 602 | NOT APPLIED ANY OIL | TEST SAMPLE MATERIAL 4 | TEST SAMPLE MATERIAL 2 |
| 603 | KEROSENE ONLY | TEST SAMPLE MATERIAL 2 | TEST SAMPLE MATERIAL 2 |
| | (NOT INCLUDING | | |
| | ANY ETHER COMPOUND) | | |
| 604 | NOT APPLIED ANY OIL | TEST SAMPLE MATERIAL 2 | TEST SAMPLE MATERIAL 2 |
| 605 | NOT APPLIED ANY OIL | TEST SAMPLE MATERIAL 4 | TEST SAMPLE MATERIAL 2 |
| 606 | KEROSENE ONLY | TEST SAMPLE MATERIAL 2 | TEST SAMPLE MATERIAL 2 |
| | (NOT INCLUDING | | |
| | ANY ETHER COMPOUND) | | |

| | | | INCREASE OF RESISTANCE | | |
|---|---|---|---|---|---|
| | | | THE NUMBER | THE NUMBER | THE NUMBER |
| TEST | | | OF TIMES | OF TIMES | OF TIMES |
| SAMPLE | PROPERTY | INITIAL | FROM ZERO | FROM 1000 | FROM 3000 |
| BODY No. | OF SLIDING | RESISTANCE | TO 1000 | TO 3000 | TO 10000 |
| 601 | X | ◯ | X | X | X |
| 602 | X | ◯ | X | X | X |
| 603 | ◯ | X | X | X | X |
| 604 | X | ◯ | X | X | X |
| 605 | X | ◯ | X | X | X |
| 606 | ◯ | X | X | X | X |

As it is obvious in accordance with each of the results that are described above respectively, it becomes clear that each of the test sample bodies in accordance with the present invention that are shown in Table 1 through Table 5 becomes to have the property of fretting resistance as superior therein respectively, that each of such the test sample bodies has the property of sliding as excellently, and that it becomes possible to connect with a force for insertion thereinto as lower in the case where there is designed for each of such the test sample bodies to be produced as a male terminal or as a female terminal respectively.

Moreover, in accordance with the present invention, it becomes able to obtain an advantage as superior thereto that it becomes able to suppress the increase of the contact resistance even after performing the slight sliding as repetitively with the number of times as 1000. For example, it is able to maintain the contact resistance within a practical range for the slight sliding till the number of times as 3000 regarding the body in which there is made use of the pentaphenyl ether therefor. Furthermore, it is able to obtain the result as remarkably that regarding the body in which there is made use of such as the alkyl diphenyl ether or the like therefor there becomes to be almost no increase of the contact resistance thereof from the number of times for the slight sliding as 1000 till the number of times therefor as 10000, for example.

Moreover, there is obtained the ratio of mass of Sn to be as approximately twenty percent regarding the test sample material 3 that is made use for the present embodiment. However, there becomes to be worsened the property of the heat resistance thereof in such the case where there is designed for the concentration of the Sn therein to be as excessively lower. And hence there becomes to be brought an increase of the resistance at an early stage thereof in a case where there is made use of such a connector under an environment at a temperature as higher. And therefore it is desirable for such the ratio of mass of the Sn therein to be as not lower than fifty percent for the total of the surface layer therein. For example, it is able to form a plating so that there becomes to be existing together the two types of the intermetallic compounds of the Cu₃Sn and the Cu₆Sn₅ therein, and then it is able to design for such the ratio of mass of the Sn therein to be as not lower than fifty percent for the total of the surface layer therein, or it is able to design as further preferably for such the ratio of mass of the Sn therein to be as not lower than fifty-one percent therefor. And then even in such the case thereof, it becomes able to obtain a result as similar to the result regarding the test sample material 3 that is described above.

Moreover, it is preferable to adopt the test sample materials from 1 through 5 that individually there is not contained any Au or any Ag therein at all respectively, that both are high priced from a point of view of manufacturing cost therefor, comparing to the other test sample materials of 6 and 7. Further, it is practical that regarding a connector in which there is made use of a process of a plating of Au thereon in particular, there is designed for such a plating to be formed only on to a connection part of the connector and then that there becomes to be made use of such the connector therefor. Furthermore, it is desirable to design for the organic coating therein to be formed only on to such the connection part thereof as well, on which there is designed for such the plating of Au to be formed thereto.

TABLE 7

| | | | TEST SAMPLE | | | |
|---|---|---|---|---|---|---|
| | ORGANIC COATING FILM LAYER | | MATERIAL | | | |
| | NATURE | | SIDE | SIDE | | |
| TEST | OF | | OF | OF | | |
| SAMPLE | ETHER | THICKNESS | THE | THE | PROPERTY | INITIAL |
| BODY No. | COMPOUND | (μm) | PLATE | INDENT | OF SLIDING | RESISTANCE |
| 801 | DIPROPYL ETHER | 0.00005 | TEST | TEST | ◯ | ◯ |
| | | | SAMPLE | SAMPLE | | |
| 802 | DIPROPYL ETHER | 0.0001 | TEST | TEST | ◯ | ◯ |
| | | | SAMPLE | SAMPLE | | |
| 803 | DIPROPYL ETHER | 0.0005 | TEST | TEST | ◯ | ◯ |
| | | | SAMPLE | SAMPLE | | |
| 804 | DIPROPYL ETHER | 0.001 | TEST | TEST | ◯ | ◯ |
| | | | SAMPLE | SAMPLE | | |
| 805 | DIPROPYL ETHER | 0.005 | TEST | TEST | ◯ | ◯ |
| | | | SAMPLE | SAMPLE | | |
| 806 | DIPROPYL ETHER | 0.01 | TEST | TEST | ◯ | ◯ |
| | | | SAMPLE | SAMPLE | | |
| 807 | DIPROPYL ETHER | 0.05 | TEST | TEST | ◯ | ◯ |
| | | | SAMPLE | SAMPLE | | |
| 808 | DIPROPYL ETHER | 0.1 | TEST | TEST | ◯ | ◯ |
| | | | SAMPLE | SAMPLE | | |
| 809 | DIPROPYL ETHER | 0.5 | TEST | TEST | ◯ | ◯ |
| | | | SAMPLE | SAMPLE | | |
| 810 | PENTAPHENYL ETHER | 0.00005 | TEST | TEST | ◯ | ◯ |
| | | | SAMPLE | SAMPLE | | |
| 811 | PENTAPHENYL ETHER | 0.0001 | TEST | TEST | ◯ | ◯ |
| | | | SAMPLE | SAMPLE | | |
| 812 | PENTAPHENYL ETHER | 0.005 | TEST | TEST | ◯ | ◯ |
| | | | SAMPLE | SAMPLE | | |
| 813 | NONYLDIPHENYL ETHER | 0.00005 | TEST | TEST | ◯ | ◯ |
| | | | SAMPLE | SAMPLE | | |
| 814 | NONYLDIPHENYL ETHER | 0.0001 | TEST | TEST | ◯ | ◯ |
| | | | SAMPLE | SAMPLE | | |
| 815 | NONYLDIPHENYL ETHER | 0.005 | TEST | TEST | ◯ | ◯ |
| | | | SAMPLE | SAMPLE | | |
| 816 | ALLYL PHENYL ETHER | 0.00005 | TEST | TEST | ◯ | ◯ |
| | | | SAMPLE | SAMPLE | | |
| 817 | ALLYL PHENYL ETHER | 0.0001 | TEST | TEST | ◯ | ◯ |
| | | | SAMPLE | SAMPLE | | |
| 818 | ALLYL PHENYL ETHER | 0.005 | TEST | TEST | ◯ | ◯ |
| | | | SAMPLE | SAMPLE | | |
| 819 | ETHYL ISOBUTYL ETHER | 0.00005 | TEST | TEST | ◯ | ◯ |
| | | | SAMPLE | SAMPLE | | |
| 820 | ETHYL ISOBUTYL ETHER | 0.0001 | TEST | TEST | ◯ | ◯ |
| | | | SAMPLE | SAMPLE | | |
| 821 | ETHYL ISOBUTYL ETHER | 0.005 | TEST | TEST | ◯ | ◯ |
| | | | SAMPLE | SAMPLE | | |
| 822 | ETHYLENE GLYCOL | 0.00005 | TEST | TEST | ◯ | ◯ |
| | DIPHENYL ETHER | | SAMPLE | SAMPLE | | |
| 823 | ETHYLENE GLYCOL | 0.0001 | TEST | TEST | ◯ | ◯ |
| | DIPHENYL ETHER | | SAMPLE | SAMPLE | | |
| 824 | ETHYLENE GLYCOL | 0.005 | TEST | TEST | ◯ | ◯ |
| | DIPHENYL ETHER | | SAMPLE | SAMPLE | | |
| 825 | TETRAPHENYL ETHER | 0.00005 | TEST | TEST | ◯ | ◯ |
| | | | SAMPLE | SAMPLE | | |
| 826 | TETRAPHENYL ETHER | 0.0001 | TEST | TEST | ◯ | ◯ |
| | | | SAMPLE | SAMPLE | | |
| 827 | TETRAPHENYL ETHER | 0.005 | TEST | TEST | ◯ | ◯ |
| | | | SAMPLE | SAMPLE | | |
| 828 | TRIPHENYL ETHER | 0.00005 | TEST | TEST | ◯ | ◯ |
| | | | SAMPLE | SAMPLE | | |
| 829 | TRIPHENYL ETHER | 0.0001 | TEST | TEST | ◯ | ◯ |
| | | | SAMPLE | SAMPLE | | |
| 830 | TRIPHENYL ETHER | 0.005 | TEST | TEST | ◯ | ◯ |
| | | | SAMPLE | SAMPLE | | |
| 831 | DIPROPYL ETHER | 0.00005 | TEST | TEST | ◯ | ◯ |
| | | | SAMPLE | SAMPLE | | |
| 832 | DIPROPYL ETHER | 0.0001 | TEST | TEST | ◯ | ◯ |
| | | | SAMPLE | SAMPLE | | |
| 833 | DIPROPYL ETHER | 0.005 | TEST | TEST | ◯ | ◯ |
| | | | SAMPLE | SAMPLE | | |
| 834 | DIPROPYL ETHER | 0.00005 | TEST | TEST | ◯ | ◯ |
| | | | SAMPLE | SAMPLE | | |
| 835 | DIPROPYL ETHER | 0.0001 | TEST | TEST | ◯ | ◯ |
| | | | SAMPLE | SAMPLE | | |
| 836 | DIPROPYL ETHER | 0.005 | TEST | TEST | ◯ | ◯ |
| | | | SAMPLE | SAMPLE | | |

| | INCREASE OF RESISTANCE | | | |
|---|---|---|---|---|
| | THE NUMBER | THE NUMBER | THE NUMBER | |
| TEST | OF TIMES | OF TIMES | OF TIMES | |
| SAMPLE | FROM ZERO | FROM 1000 | FROM 3000 | |
| BODY No. | TO 1000 | TO 3000 | TO 10000 | APPEARANCE |
| 801 | ◯ | Δ | X | ◯ |
| 802 | ◯ | ◯ | Δ | ◯ |
| 803 | ◯ | ◯ | ◯ | ◯ |
| 804 | ◯ | ◯ | ◯ | ◯ |
| 805 | ◯ | ◯ | ◯ | ◯ |
| 806 | ◯ | ◯ | ◯ | ◯ |
| 807 | ◯ | ◯ | ◯ | Δ |
| 808 | ◯ | ◯ | ◯ | Δ |
| 809 | ◯ | ◯ | ◯ | X |
| 810 | Δ | X | X | ◯ |
| 811 | ◯ | ◯ | Δ | ◯ |
| 812 | ◯ | ◯ | ◯ | ◯ |
| 813 | ◯ | Δ | X | ◯ |
| 814 | ◯ | ◯ | ◯ | ◯ |
| 815 | ◯ | ◯ | ◯ | ◯ |
| 816 | ◯ | Δ | X | ◯ |
| 817 | ◯ | ◯ | ◯ | ◯ |
| 818 | ◯ | ◯ | ◯ | ◯ |
| 819 | ◯ | Δ | X | ◯ |
| 820 | ◯ | ◯ | ◯ | ◯ |
| 821 | ◯ | ◯ | ◯ | ◯ |
| 822 | ◯ | Δ | X | ◯ |
| 823 | ◯ | ◯ | ◯ | ◯ |
| 824 | ◯ | ◯ | ◯ | ◯ |
| 825 | ◯ | Δ | X | ◯ |
| 826 | ◯ | ◯ | ◯ | ◯ |
| 827 | ◯ | ◯ | ◯ | ◯ |
| 828 | ◯ | Δ | X | ◯ |
| 829 | ◯ | ◯ | ◯ | ◯ |
| 830 | ◯ | ◯ | ◯ | ◯ |
| 831 | ◯ | Δ | X | ◯ |
| 832 | ◯ | ◯ | ◯ | ◯ |
| 833 | ◯ | ◯ | ◯ | ◯ |
| 834 | ◯ | Δ | X | ◯ |
| 835 | ◯ | ◯ | ◯ | ◯ |
| 836 | ◯ | ◯ | ◯ | ◯ |

As it is obvious in accordance with the result of Table 7, it becomes able to obtain the result that in the case where there is changed the thickness of the organic coating of each of the test sample bodies in accordance with the present invention, there is almost no increase in the contact resistance thereof in the range thereof as between 0.0001 μm and 0.1 μm respectively, and that it is preferred regarding each of the appearance thereof as well respectively. However, there is obtained the result that there becomes to be anxious about the appearance thereof and a handling ability at a period of working therefor, that is to say, a stickiness in the case where there is designed for the organic coating to have the thickness as thicker than 0.1 μm regarding also the other ether compounds than regarding the dipropyl ether, and hence it is not able to obtain any preferred result at all on the contrary thereto.

TABLE 8

| | | | | TEST SAMPLE | | |
|---|---|---|---|---|---|---|
| | ETHER COMPOUND | | | MATERIAL | | |
| | NATURE | | | SIDE | SIDE | |
| TEST | OF | | | OF | OF | |
| SAMPLE | ETHER | CONTENT | | THE | THE | PROPERTY |
| BODY No. | COMPOUND | (MASS %) | VOLATILE SOLVENT | PLATE | INDENT | OF SLIDING |
| 901 | DIPROPYL ETHER | 0.005 | KEROSENE | TEST | TEST | ◯ |
| | | | | SAMPLE | SAMPLE | |
| 902 | DIPROPYL ETHER | 0.01 | KEROSENE | TEST | TEST | ◯ |
| | | | | SAMPLE | SAMPLE | |
| 903 | DIPROPYL ETHER | 1 | KEROSENE | TEST | TEST | ◯ |
| | | | | SAMPLE | SAMPLE | |
| 904 | DIPROPYL ETHER | 5 | KEROSENE | TEST | TEST | ◯ |
| | | | | SAMPLE | SAMPLE | |
| 905 | DIPROPYL ETHER | 10 | KEROSENE | TEST | TEST | ◯ |
| | | | | SAMPLE | SAMPLE | |
| 906 | DIPROPYL ETHER | 20 | KEROSENE | TEST | TEST | ◯ |
| | | | | SAMPLE | SAMPLE | |
| 907 | DIPROPYL ETHER | 50 | KEROSENE | TEST | TEST | ◯ |
| | | | | SAMPLE | SAMPLE | |
| 908 | DIPROPYL ETHER | 80 | KEROSENE | TEST | TEST | ◯ |
| | | | | SAMPLE | SAMPLE | |
| 909 | DIPROPYL ETHER | 90 | KEROSENE | TEST | TEST | ◯ |
| | | | | SAMPLE | SAMPLE | |
| 910 | PENTAPHENYL ETHER | 0.005 | KEROSENE | TEST | TEST | ◯ |
| | | | | SAMPLE | SAMPLE | |
| 911 | PENTAPHENYL ETHER | 5 | KEROSENE | TEST | TEST | ◯ |
| | | | | SAMPLE | SAMPLE | |
| 912 | PENTAPHENYL ETHER | 20 | KEROSENE | TEST | TEST | ◯ |
| | | | | SAMPLE | SAMPLE | |
| 913 | NONYLDIPHENYL ETHER | 0.005 | KEROSENE | TEST | TEST | ◯ |
| | | | | SAMPLE | SAMPLE | |
| 914 | NONYLDIPHENYL ETHER | 5 | KEROSENE | TEST | TEST | ◯ |
| | | | | SAMPLE | SAMPLE | |
| 915 | NONYLDIPHENYL ETHER | 20 | KEROSENE | TEST | TEST | ◯ |
| | | | | SAMPLE | SAMPLE | |
| 916 | ALLYL PHENYL ETHER | 0.005 | KEROSENE | TEST | TEST | ◯ |
| | | | | SAMPLE | SAMPLE | |
| 917 | ALLYL PHENYL ETHER | 5 | KEROSENE | TEST | TEST | ◯ |
| | | | | SAMPLE | SAMPLE | |
| 918 | ALLYL PHENYL ETHER | 20 | KEROSENE | TEST | TEST | ◯ |
| | | | | SAMPLE | SAMPLE | |
| 919 | ETHYL ISOBUTYL ETHER | 0.005 | KEROSENE | TEST | TEST | ◯ |
| | | | | SAMPLE | SAMPLE | |
| 920 | ETHYL ISOBUTYL ETHER | 5 | KEROSENE | TEST | TEST | ◯ |
| | | | | SAMPLE | SAMPLE | |
| 921 | ETHYL ISOBUTYL ETHER | 20 | KEROSENE | TEST | TEST | ◯ |
| | | | | SAMPLE | SAMPLE | |
| 922 | ETHYLENE GLYCOL | 0.005 | KEROSENE | TEST | TEST | ◯ |
| | DIPHENYL ETHER | | | SAMPLE | SAMPLE | |
| 923 | ETHYLENE GLYCOL | 5 | KEROSENE | TEST | TEST | ◯ |
| | DIPHENYL ETHER | | | SAMPLE | SAMPLE | |
| 924 | ETHYLENE GLYCOL | 20 | KEROSENE | TEST | TEST | ◯ |
| | DIPHENYL ETHER | | | SAMPLE | SAMPLE | |
| 925 | TETRAPHENYL ETHER | 0.005 | KEROSENE | TEST | TEST | ◯ |
| | | | | SAMPLE | SAMPLE | |
| 926 | TETRAPHENYL ETHER | 5 | KEROSENE | TEST | TEST | ◯ |
| | | | | SAMPLE | SAMPLE | |
| 927 | TETRAPHENYL ETHER | 20 | KEROSENE | TEST | TEST | ◯ |
| | | | | SAMPLE | SAMPLE | |
| 928 | TRIPHENYL ETHER | 0.005 | KEROSENE | TEST | TEST | ◯ |
| | | | | SAMPLE | SAMPLE | |
| 929 | TRIPHENYL ETHER | 5 | KEROSENE | TEST | TEST | ◯ |
| | | | | SAMPLE | SAMPLE | |
| 930 | TRIPHENYL ETHER | 20 | KEROSENE | TEST | TEST | ◯ |
| | | | | SAMPLE | SAMPLE | |
| 931 | DIPROPYL ETHER | 0.005 | ACETONE | TEST | TEST | ◯ |
| | | | | SAMPLE | SAMPLE | |
| 932 | DIPROPYL ETHER | 5 | ACETONE | TEST | TEST | ◯ |
| | | | | SAMPLE | SAMPLE | |
| 933 | DIPROPYL ETHER | 20 | ACETONE | TEST | TEST | ◯ |
| | | | | SAMPLE | SAMPLE | |
| 934 | DIPROPYL ETHER | 0.005 | TRICHLOROETHANE | TEST | TEST | ◯ |
| | | | | SAMPLE | SAMPLE | |
| 935 | DIPROPYL ETHER | 5 | TRICHLOROETHANE | TEST | TEST | ◯ |
| | | | | SAMPLE | SAMPLE | |
| 936 | DIPROPYL ETHER | 20 | TRICHLOROETHANE | TEST | TEST | ◯ |
| | | | | SAMPLE | SAMPLE | |

| | | INCREASE OF RESISTANCE | | | |
|---|---|---|---|---|---|
| | | THE NUMBER | THE NUMBER | THE NUMBER | |
| TEST | | OF TIMES | OF TIMES | OF TIMES | |
| SAMPLE | INITIAL | FROM ZERO | FROM 1000 | FROM 3000 | |
| BODY No. | RESISTANCE | TO 1000 | TO 3000 | TO 10000 | APPEARANCE |
| 901 | ◯ | ◯ | Δ | X | ◯ |
| 902 | ◯ | ◯ | ◯ | Δ | ◯ |
| 903 | ◯ | ◯ | ◯ | ◯ | ◯ |
| 904 | ◯ | ◯ | ◯ | ◯ | ◯ |
| 905 | ◯ | ◯ | ◯ | ◯ | ◯ |
| 906 | ◯ | ◯ | ◯ | ◯ | ◯ |
| 907 | ◯ | ◯ | ◯ | ◯ | Δ |
| 908 | ◯ | ◯ | ◯ | ◯ | X |
| 909 | ◯ | ◯ | ◯ | ◯ | X |
| 910 | ◯ | Δ | X | X | ◯ |
| 911 | ◯ | ◯ | ◯ | Δ | ◯ |
| 912 | ◯ | ◯ | ◯ | Δ | ◯ |
| 913 | ◯ | ◯ | Δ | X | ◯ |
| 914 | ◯ | ◯ | ◯ | ◯ | ◯ |
| 915 | ◯ | ◯ | ◯ | ◯ | ◯ |
| 916 | ◯ | ◯ | Δ | X | ◯ |
| 917 | ◯ | ◯ | ◯ | ◯ | ◯ |
| 918 | ◯ | ◯ | ◯ | ◯ | ◯ |
| 919 | ◯ | ◯ | Δ | X | ◯ |
| 920 | ◯ | ◯ | ◯ | ◯ | ◯ |
| 921 | ◯ | ◯ | ◯ | ◯ | ◯ |
| 922 | ◯ | ◯ | Δ | X | ◯ |
| 923 | ◯ | ◯ | ◯ | ◯ | ◯ |
| 924 | ◯ | ◯ | ◯ | ◯ | ◯ |
| 925 | ◯ | ◯ | Δ | X | ◯ |
| 926 | ◯ | ◯ | ◯ | ◯ | ◯ |
| 927 | ◯ | ◯ | ◯ | ◯ | ◯ |
| 928 | ◯ | ◯ | Δ | X | ◯ |
| 929 | ◯ | ◯ | ◯ | ◯ | ◯ |
| 930 | ◯ | ◯ | ◯ | ◯ | ◯ |
| 931 | ◯ | ◯ | Δ | X | ◯ |
| 932 | ◯ | ◯ | ◯ | ◯ | ◯ |
| 933 | ◯ | ◯ | ◯ | ◯ | ◯ |
| 934 | ◯ | ◯ | Δ | X | ◯ |
| 935 | ◯ | ◯ | ◯ | ◯ | ◯ |
| 936 | ◯ | ◯ | ◯ | ◯ | ◯ |

As it is obvious in accordance with the result of Table 8, it becomes able to obtain the result that in the case where there is designed for the content of the ether compound in each of the test sample bodies in accordance with the present invention to be within the range thereof as between 0.01 mass percent and fifty mass percent respectively, there is almost no increase in the contact resistance thereof, and that it is preferred regarding each of the appearance thereof as well respectively. However, it is not able to obtain any preferred result at all on the contrary thereto regarding the appearance thereof in the case where there is designed for the content of the ether compound therein to be as higher than fifty mass percent regarding also the other ether compounds than regarding the dipropyl ether.

### Example 2

Here, there is performed a production of each of the test sample bodies of 701 through 704 by designing for each of the ether compounds and for each of the corresponding concentration thereof and for each of the corresponding metal materials therefor to be shown in the following Table 9, and by performing a process of press working for a male terminal in a connector in a middle period thereof, meanwhile, there are performed all the other processes therefor as similar to the individual corresponding processes that are described in Example 1. And then there is examined a test for each thereof as similar to the test of slight sliding that is described above. Moreover, there is performed a test of force for insertion with making use of the individual terminals that are shown in FIG. 1 through 3. Further, there is made use of the test sample material 1 for a female terminal and then such the female terminal is fixed by making use of a treatment device. Still further, there is assumed for a direction to a regular insertion of such a terminal at a time of the engagement for the male terminal in such the connector to be as a direction to an axis thereof. Still further, there is performed a monitoring regarding a curved line of between a displacement thereof and a load thereto at such the period thereof. And then there is evaluated a peak value of loading for such the terminal at a period till reaching to a regular position of the engagement thereof to be assumed as a force for inserting the terminal thereinto. Furthermore, there is designed for the dimple part (22) of the female terminal therein to have a contact pressure of 6.4 N at the period thereof, and then there is determined for the force for insertion of the terminal thereinto to be as “∘ (GOOD)” in a case of weaker than 3.0 N, meanwhile, there is designed therefor to be as “Δ (ACCEPTABLE)” in a case of not weaker than 3.0 N but weaker than 3.5 N on the contrary thereto, and meanwhile, there is determined therefor to be as “x (NO GOOD)” in a case of stronger than 3.5 N on the contrary thereto.

TABLE 9

| TEST | | | | | PROPERTY OF |
|---|---|---|---|---|---|
| SAMPLE | ETHER | | TEST SAMPLE | FORCE FOR | FRETTING |
| BODY | COMPOUND | CONCENTRATION | MATERIAL | INSERTION | RESISTANCE |
| 701 | PENTAPHENYL | 4% | 1 | ◯ | ◯ |
| | ETHER | | | | |
| 702 | PENTAPHENYL | 4% | 3 | ◯ | ◯ |
| | ETHER | | | | |
| 703 | PENTAPHENYL | 3% | 1 | ◯ | ◯ |
| | ETHER | | | | |
| 704 | NONE | — | 1 | X | X |

In accordance with each of the results that are described above, it becomes clear that it becomes able to maintain the functions as superior thereto even in the case where there is performed the process of the application of the specified ether compound thereto in the period of the process of press working therefor regarding each of the test sample bodies of 701 and 702 and 703 for the individual male terminals in the individual corresponding connectors in accordance with the present invention, that individually are different from the test sample body of 704 that is in order to compare thereto respectively, that it becomes able to connect each of such the terminals with the force for insertion thereinto as weaker respectively, and that it becomes able to obtain the property of the fretting resistance as superior thereto as well respectively.

### Example 3

Next, there is performed a production of each of the test sample bodies of 801 through 804 by designing for each of the ether compounds to be made use of a pentaphenyl ether with having a concentration of approximately four mass percent therein, and by performing a process of press working for each of the male terminals in a connector and/or each of the female terminals therein to be as shown in the following Table 10, meanwhile, there are performed all the other processes therefor as similar to the individual corresponding processes that are described in Example 1. And then there is examined a test for each thereof as similar to the test of slight sliding that is described above.

TABLE 10

| TEST | TERMINAL HAVING | FORCE | PROPERTY OF |
|---|---|---|---|
| SAMPLE | AN ORGANIC | FOR | FRETTING |
| BODY | COATING FILM LAYER | INSERTION | RESISTANCE |
| 801 | MALE TERMINAL ONLY | ◯ | ◯ |
| 802 | FEMALE TERMINAL | Δ | ◯ |
| | ONLY | | |
| 803 | MALE TERMINAL AND | ◯ | ◯ |
| | FEMALE TERMINAL | | |
| 804 | NONE | X | X |

In accordance with each of the results that are described above, it becomes clear that it becomes able to maintain the functions as superior thereto even in the case where there is performed the process of the application of the specified ether compound thereto in the period of the process of press working therefor regarding each of the test sample bodies of 801 and 802 and 803 for the individual male terminals in the individual corresponding connectors in accordance with the present invention and/or for the individual female terminals therein, that individually are different from the test sample body of 804 that is in order to compare thereto respectively, that it becomes able to connect each of such the terminals with the force for insertion thereinto as weaker respectively, and that it becomes able to obtain the property of the fretting resistance as superior thereto as well respectively. And it becomes clear that it becomes able to obtain the force for insertion thereinto as further lower because there is designed for such the male terminal therein in particular to be provided the organic coating thereto, comparing to the test sample body of 802 in which there is designed only for the female terminal therein to be provided the organic coating thereto. And therefore it becomes able to reduce such the force for insertion thereinto as effectively by designing for a male terminal therein to comprise the configuration in accordance with the present invention by which there is designed for such the male terminal therein to have an area of a face for contacting thereto comparing to that of a female terminal therein at the time of inserting such the male terminal into such the female terminal therein.

### INDUSTRIAL APPLICABILITY

Here it becomes able to apply such the fretting-resistant connector in accordance with the present invention as preferred to a fretting-resistant connector with including a male terminal and a female terminal, that it becomes able to connect thereto with a force for insertion thereinto as lower, that is superior in a property of a fretting resistance, and that it becomes possible to maintain an electrical conduction therebetween as excellently even in a case where there becomes to be wearing a contact part of the terminal therein due to such as a slight vibration or the like.

Moreover, it becomes able to apply such the process for manufacturing a fretting-resistant connector in accordance with the present invention as preferred to a process for manufacturing, by which it becomes able to perform the process as efficiently for manufacturing such the connector that is described above and that is superior therein.

Thus, there is described as above regarding the present invention in reference to the embodiment therefor, however, the present invention will not be limited to every detail of the description as far as a particular designation therefor, and it should be interpreted widely without departing from the spirit and scope of the present invention as disclosed in the attached claims.

Furthermore, the present invention claims the priority based on Japanese Patent Application No. 2007-173335, that is patent applied in Japan on the twenty-ninth day of June 2007, and the entire contents of which are expressly incorporated herein by reference.

1-11. (canceled)

12. A fretting-resistant connector, comprising:
an organic coating that is formed of an organic compound which has an ether linkage group at least a part on a surface of an electrically conductive metal material; and said organic compound in order to form said organic coating is formed of only said ether linkage group and a hydrophobic group.

13. The fretting-resistant connector according to claim 12, wherein said hydrophobic group therein is formed of a hydrocarbon group.

14. The fretting-resistant connector according to claim 12, wherein said connector is configured of a male terminal and a female terminal as not less than one for each thereof, and said organic coating is formed on to at least said part on said surface of said electrically conductive metal material that forms said male terminal.

15. The fretting-resistant connector according to claim 13, wherein said connector is configured of a male terminal and a female terminal as not less than one for each thereof, and said organic coating is formed on to at least said part on said surface of said electrically conductive metal material that forms said male terminal.

16. The fretting-resistant connector according to claim 14, wherein said male terminal comprises a part for connection in order to be connected said female terminal thereto, and said organic coating is formed on to at least a part on said surface of said electrically conductive metal material that forms said part for connection as well.

17. The fretting-resistant connector according to claim 15, wherein said male terminal comprises a part for connection in order to be connected said female terminal thereto, and said organic coating is formed on to at least a part on said surface of said electrically conductive metal material that forms said part for connection as well.

18. The fretting-resistant connector according to claim 12, wherein a thickness of said organic coating is between 0.0001 μm and 0.1 μm.

19. The fretting-resistant connector according to claim 13, wherein a thickness of said organic coating is between 0.0001 μm and 0.1 μm.

20. The fretting-resistant connector according to claim 14, wherein a thickness of said organic coating is between 0.0001 μm and 0.1 μm.

21. The fretting-resistant connector according to claim 12, wherein there is designed for said electrically conductive metal material to be provided an electrically conductive surface layer that is formed of tin, or gold, or silver, or copper, or an intermetallic compound of copper and tin, or an intermetallic compound of nickel and tin, or an intermetallic compound of tin and silver, or to be provided an electrically conductive surface layer that is formed of a metal composition in which there is designed for tin to be dispersed at a side of a surface of a layer that is formed of any one of said intermetallic compounds, on to an electrically conductive substance.

22. The fretting-resistant connector according to claim 13, wherein there is designed for said electrically conductive metal material to be provided an electrically conductive surface layer that is formed of tin, or gold, or silver, or copper, or an intermetallic compound of copper and tin, or an intermetallic compound of nickel and tin, or an intermetallic compound of tin and silver, or to be provided an electrically conductive surface layer that is formed of a metal composition in which there is designed for tin to be dispersed at a side of a surface of a layer that is formed of any one of said intermetallic compounds, on to an electrically conductive substance.

23. The fretting-resistant connector according to claim 14, wherein there is designed for said electrically conductive metal material to be provided an electrically conductive surface layer that is formed of tin, or gold, or silver, or copper, or an intermetallic compound of copper and tin, or an intermetallic compound of nickel and tin, or an intermetallic compound of tin and silver, or to be provided an electrically conductive surface layer that is formed of a metal composition in which there is designed for tin to be dispersed at a side of a surface of a layer that is formed of any one of said intermetallic compounds, on to an electrically conductive substance.

24. The fretting-resistant connector according to claim 18, wherein there is designed for said electrically conductive metal material to be provided an electrically conductive surface layer that is formed of tin, or gold, or silver, or copper, or an intermetallic compound of copper and tin, or an intermetallic compound of nickel and tin, or an intermetallic compound of tin and silver, or to be provided an electrically conductive surface layer that is formed of a metal composition in which there is designed for tin to be dispersed at a side of a surface of a layer that is formed of any one of said intermetallic compounds, on to an electrically conductive substance.

25. A process for manufacturing the fretting-resistant connector, comprising the steps of:
coating an ether compound or a solution in which said ether compound is included in a solvent on to a surface of an electrically conductive metal material; and
preventing a coating film layer that is formed of said ether compound on to said surface of said electrically conductive metal material; or
dispersing and then adsorbing said ether compound on to said surface of said electrically conductive metal material.

26. The process for manufacturing the fretting-resistant connector according to claim 25, wherein there is processed for said ether compound to be formed of only an ether linkage group and a hydrophobic group.

27. The process for manufacturing the fretting-resistant connector according to claim 25, wherein there is designed to be made use of a volatile solvent for said solvent, and there is processed for said solution in which said ether compound is included in said solvent as between 0.01 mass percent and fifty mass percent to coat on to said electrically conductive metal material.

28. The process for manufacturing the fretting-resistant connector according to claim 26, wherein there is designed to be made use of a volatile solvent for said solvent, and there is processed for said solution in which said ether compound is included in said solvent as between 0.01 mass percent and fifty mass percent to coat on to said electrically conductive metal material.

29. The process for manufacturing the fretting-resistant connector according to claim 25, wherein there is designed for said electrically conductive metal material to be formed by performing a process of punching and by performing a process of bending, after performing a process of coating said solution thereto, or with performing said process of coating said solution thereto.

30. The process for manufacturing the fretting-resistant connector according to claim 26, wherein there is designed for said electrically conductive metal material to be formed by performing a process of punching and by performing a process of bending, after performing a process of coating said solution thereto, or with performing said process of coating said solution thereto.

31. The process for manufacturing the fretting-resistant connector according to claim 27, wherein there is designed for said electrically conductive metal material to be formed by performing a process of punching and by performing a process of bending, after performing a process of coating said solution thereto, or with performing said process of coating said solution thereto.
